(19) United States
(12) Patent Application Publication
(10) Pub. No.: US 2026/0064924 A1
(43) Pub. Date: Mar. 5, 2026

(54) SYSTEMS AND METHODS FOR DESIGNING A MODULE PRODUCT

(71) Applicant: SEMICONDUCTOR COMPONENTS INDUSTRIES, LLC, Scottsdale, AZ (US)

(72) Inventor: James Joseph VICTORY, Trabuco Canyon, CA (US)

(73) Assignee: SEMICONDUCTOR COMPONENTS INDUSTRIES, LLC, Scottsdale, AZ (US)

(21) Appl. No.: 19/384,711

(22) Filed: Nov. 10, 2025

Related U.S. Application Data
(63) Continuation-in-part of application No. 18/539,697, filed on Dec. 14, 2023.
Application No. 18/539,697 is a continuation of application No. 17/930,091, filed on Sep. 7, 2022, now Pat. No. 11,880,642.
Application No. 17/930,091 is a continuation of application No. 17/076,039, filed on Oct. 21, 2020, now Pat. No. 11,481,532.
(63) Continuation-in-part of application No. 18/058,382, filed on Nov. 23, 2022.
(60) Provisional application No. 62/923,615, filed on Oct. 21, 2019.

(51) Int. Cl. G06F 30/31; G06F 30/367; G06F 30/392; G06F 30/398; G06F 111/02; G06F 117/12; G06F 119/08; G06N 3/04; G06N 3/08

(52) U.S. Cl. CPC G06F 30/31; G06F 30/367; G06F 30/392; G06F 30/398; G06N 3/04; G06N 3/08; G06F 2111/02; G06F 2117/12; G06F 2119/08

(57) ABSTRACT

Implementations of a method of designing a semiconductor device product may include selecting of at least one discrete device die at least one test condition; generating a product die and package configuration using a predictive modeling module and the at least one discrete device die; generating a graphic design system file with the product die configuration; generating a package bonding diagram with the graphic design system file; generating a product SPICE model corresponding with the product die configuration; generating one or more datasheet characteristics of a discrete device product with the product SPICE model; generating a product datasheet for the discrete device product using the graphic design system file, the package bonding diagram, and the one or more datasheet characteristics; and providing access to the graphic design system file, the package bonding diagram, the product SPICE model, and the product datasheet.

### CROSS REFERENCE TO RELATED APPLICATIONS

This application is a continuation-in-part application of the earlier U.S. Utility Patent Application to Victory et al. entitled “Systems and Methods for Designing a Discrete Device Product,” application Ser. No. 18/539,697, filed Dec. 14, 2023, now pending, which application is a continuation application of the earlier U.S. Utility Patent Application to Victory et al. entitled “Systems and Methods for Designing a Discrete Device Product,” application Ser. No. 17/930,091, filed Sep. 7, 2022, now issued as U.S. Pat. No. 11,880,642, which application is a continuation application of the earlier U.S. Utility Patent Application to Victory et al. entitled “Systems and Methods for Designing a Discrete Device Product,” application Ser. No. 17/076,039, filed Oct. 21, 2020, now issued as U.S. Pat. No. 11,481,532, which application claims the benefit of the filing date of U.S. Provisional Patent Application 62/923,615, entitled “System, Apparatus, and Methods for Custom and/or Automated Design of Semiconductor Devices” to Victory et al. which was filed on Oct. 21, 2019, the disclosures of each of which are hereby incorporated entirely herein by reference.

This application is also a continuation-in-part application of the earlier U.S. Utility Patent Application to Xiao et al. entitled “Automated Power Discrete and Module Model Generation for System Level Simulators,” application Ser. No. 18/058,382, filed Nov. 23, 2022, now pending, the disclosure of which is hereby incorporated entirely herein by reference.

### TECHNICAL FIELD

Aspects of this document relate generally to systems and methods, such as systems and methods for designing a discrete device product. More specific implementations involve systems and methods for automated electronic component design.

### BACKGROUND

Electronic components include a wide variety of devices including transistors, resistors, capacitors, and other devices designed to manipulate/control electrical charge. Microprocessors include various electronic components assembled on a single integrated circuit design that are capable of performing various analog or digital calculations.

### SUMMARY

Implementations of a system configured for designing a semiconductor device product may include one or more hardware processors configured by machine-readable instructions to: provide access to the system using a portal interface. The system may include, using a product design interface, receiving a selection of a discrete device product design option and activating a discrete device product system configured to: receive from a user a selection of at least one discrete device die and a selection of at least one test condition and generate a product die configuration using the at least one discrete device die and a predictive modeling module. The system may further include generating a graphic design system file using a graphic design system module with the product die configuration; generating a package bonding diagram using a build diagram system module with the graphic design system file; generating a product SPICE model corresponding with the product die configuration with a product SPICE model generating module; providing the product SPICE model to a product simulation module; and generating one or more datasheet characteristics of a discrete device product with the product SPICE model using the product simulation module. The system may include providing the one or more datasheet characteristics to a datasheet formation module; generating product datasheet for the discrete device product using the graphic design system file, the package bonding diagram, and the one or more datasheet characteristics; and providing access to the graphic design system file, the package bonding diagram, the product SPICE model, and the product datasheet to the user.

Implementations of a system configured for designing a semiconductor device product may include one, all, or any of the following:

The system may be further configured to receive a selection of a package type, include the package type in the product die configuration, select a die SPICE model corresponding with the at least one discrete device die, and select a package SPICE model corresponding with the package type for generating the product SPICE model with the product SPICE model generating module.

The build diagram system module may use a virtual clip to generate the package bonding diagram.

The system may include, using the one or more hardware processors configured by machine-readable instructions, receive a selection of a module type; generate a module configuration file; generate a module bonding diagram; provide the module configuration file, the module bonding diagram, and the product SPICE model to a three dimensional simulation module; generate a three dimensional model for the module using the three dimensional simulation module; and provide access to at least the module bonding diagram, a product SPICE model that includes module packaging, and the three dimensional model to the user.

The product SPICE model may include at least one die SPICE model, a module packaging parasitic extraction model, and a thermal model including module packaging.

The system may be configured to provide access to a module schematic diagram.

The system may include, using the one or more hardware processors configured by machine-readable instructions, receive a selection of a module type; generate a module configuration file; generate a module bonding diagram; provide the module configuration file, the module bonding diagram, and the product SPICE model to a three dimensional simulation module; and generate a product SPICE model that includes module packaging.

The product SPICE model that includes module packaging may include at least one die SPICE model, a module packaging parasitic extraction model, and a thermal model including module packaging.

The system may include, using the one or more hardware processors configured by machine-readable instructions, with the product SPICE model including module packaging associated with the module type, receive from the user a selection of a process condition; receive from the user one or more system characteristics and one or more operating characteristics; receive from the user one or more circuit characteristics; use a SPICE model simulation module to generate a SPICE model output with the product SPICE model that includes module packaging, the process condition, the one or more system characteristics, the one or more operating characteristics, and the one or more circuit characteristics; and use a formatting module to format the SPICE model output into a product system model file, the product system model file including one of a structured text file, a plain text file, or a delimited text file.

The product system model file may be configured to be used to perform a system level simulation of a system including the module type.

The product system model file may be a structured text file configured to be used by a Piecewise Linear Electrical Circuit Simulation system.

Implementations of a method of designing a semiconductor device product may include receiving from a user a selection of at least one discrete device die and a selection of at least one test condition; generating, using a processor, a product die configuration and a product package configuration using a predictive modeling module and the at least one discrete device die; generating, using the processor, a graphic design system file using a graphic design system module with the product die configuration; and generating, using the processor, a package bonding diagram using a build diagram system module with the graphic design system file. The method may include generating, using the processor, a product SPICE model corresponding with the product die configuration using a product SPICE model generating module; providing, using the processor, the product SPICE model to a product simulation module; generating, using the processor, one or more datasheet characteristics of a discrete device product with the product SPICE model; providing, using the processor, the one or more datasheet characteristics to a datasheet formation module; generating, using the processor, a product datasheet for the discrete device product using the graphic design system file, the package bonding diagram, and the one or more datasheet characteristics; and providing access to the graphic design system file, the package bonding diagram, the product SPICE model, and the product datasheet to the user.

Implementations of a method of designing a semiconductor device product may include one, all, or any of the following.

The method may include receiving a selection of a package type, including the package type in the product die configuration, selecting a die SPICE model corresponding with the at least one discrete device die, and selecting a package SPICE model corresponding with the package type for generating the product SPICE model with the product SPICE model generating module.

The build diagram system module may use a virtual clip to generate the package bonding diagram.

The method may include receiving a selection of a module type; generating, using the processor, a module configuration file; generating, using the processor, a module bonding diagram using a build diagram system module with the module configuration file; providing, using the processor, the module configuration file, the module bonding diagram, and the product SPICE model to a three dimensional simulation module; generating, using the processor, a product SPICE model including module packaging; generating a three dimensional model for a module semiconductor product using the three dimensional simulation module; and providing access to at least the module bonding diagram, the product SPICE model including module packaging, and the three dimensional model to the user.

The product SPICE model including module packaging includes at least one die SPICE model, a module parasitic extraction model including packaging, and a thermal model including packaging.

The method may include, using the processor, receiving from a user a selection of a product type; selecting, using a processor, the product SPICE model including module packaging associated with the module type; using the processor, receiving from the user a selection of a process condition; using the processor, receiving from the user one or more system characteristics and one or more operating characteristics; using the processor, receiving from the user one or more circuit characteristics; using the processor and a SPICE model simulation module, generating a SPICE model output with the product SPICE model, the process condition, the one or more system characteristics, the one or more operating characteristics, and the one or more circuit characteristics; and using the processor and a formatting module, formatting the SPICE model output into a product system model file, the product system model file including one of a structured text file, a plain text file, or a delimited text file.

The product system model file may be configured to be used to perform a system level simulation of a system including the product type.

The one or more operating characteristics further may include one of at least one direct current characteristic, at least one switching characteristic, at least one gate threshold voltage, or any combination thereof.

The product system model file may be a structured text file configured to be used by a Piecewise Linear Electrical Circuit Simulation system.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 illustrates a system configured for designing a discrete device product;

FIG. 2A illustrates a first portion of a flowchart of an implementation of a method for designing a discrete device product;

FIG. 2B illustrates a second portion of a flowchart of an implementation of a method for designing a discrete device product;

FIG. 3 is a diagram of an implementation of a first computer generated interface;

FIG. 4 is a diagram of an implementation of a second computer generated interface;

FIG. 5 is a diagram of another implementation of a first computer generated interface;

FIG. 6 is a diagram of a first interface generated by a computing device;

FIG. 7 is a diagram of a second interface generated by a computing device;

FIG. 8 is a diagram of a third interface generated by a computing device;

FIG. 9 is a diagram of a fourth interface generated by a computing device;

FIG. 10 is an illustration of a first portion of a system model file that includes a structured text file;

FIG. 11 is an illustration of a second portion of the system model file of FIG. 5;

FIG. 12 is an illustration of a first portion of a system model file in a file viewer that includes a structure text file;

FIG. 13 is an illustration of a second portion of a system model file of FIG. 7;

FIG. 14 illustrates an implementation of a circuit schematic included in the corresponding portion of FIG. 9;

FIG. 15 is a three-dimensional graph of system level simulation data from a system simulator using a system model file;

FIG. 16 is a graph of system level simulation data for Eoff switching loss at different temperatures and voltages versus diode current (ID) obtained using a system model file;

FIG. 17 is a graph of system level simulation data for Eoff switching loss at different diode currents (ID) obtained using a system model file;

FIG. 18 is a graph of system level simulation data for Eoff switching loss at different diode currents (ID) at different temperatures obtained using a system model file;

FIG. 19 is a graph of system level simulation data for Eon switching loss at different diode currents (ID) obtained using a system model file;

FIG. 20 is a graph of system level simulation data for Eon switching loss at different diode currents (ID) and temperatures obtained using a system model file;

FIG. 21 is a graph of system level simulation data for Vdson switching loss at different diode currents and temperatures;

FIG. 22 is a graph of system level simulation data for Vsd (voltage source-drain) at different diode currents and temperatures;

FIG. 23 is a block diagram of an implementation of a system for generating a system model for use in system level simulations;

FIG. 24 is a flow chart of an implementation of a method of generating a system model for use in system level simulations;

FIG. 25 is a flow diagram of an implementation of a system for designing a semiconductor product;

FIG. 26 illustrates an implementation of an application interface (login interface);

FIG. 27 illustrates an implementation of a simulation selection interface;

FIG. 28 illustrates an implementation of a product design interface;

FIG. 29 illustrates an implementation of a die configuration interface;

FIG. 30 illustrates an implementation of a die summary interface;

FIG. 31 illustrates an implementation of a characteristics interface;

FIG. 32 illustrates an implementation of a circuit design interface;

FIG. 33 illustrates an implementation of a model output interface;

FIG. 34 illustrates an implementation of a module characteristics interface;

FIG. 35 illustrates an implementation of another characteristics interface;

FIG. 36 illustrates an implementation of a circuit schematic configuration interface; and

FIG. 37 illustrates an implementation of a system output interface.

### DETAILED DESCRIPTION

This disclosure, its aspects and implementations, are not limited to the specific components, assembly procedures or method elements disclosed herein. Many additional components, assembly procedures and/or method elements known in the art consistent with the intended for designing a module product will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for designing a module product, and implementing components and methods, consistent with the intended operation and methods.

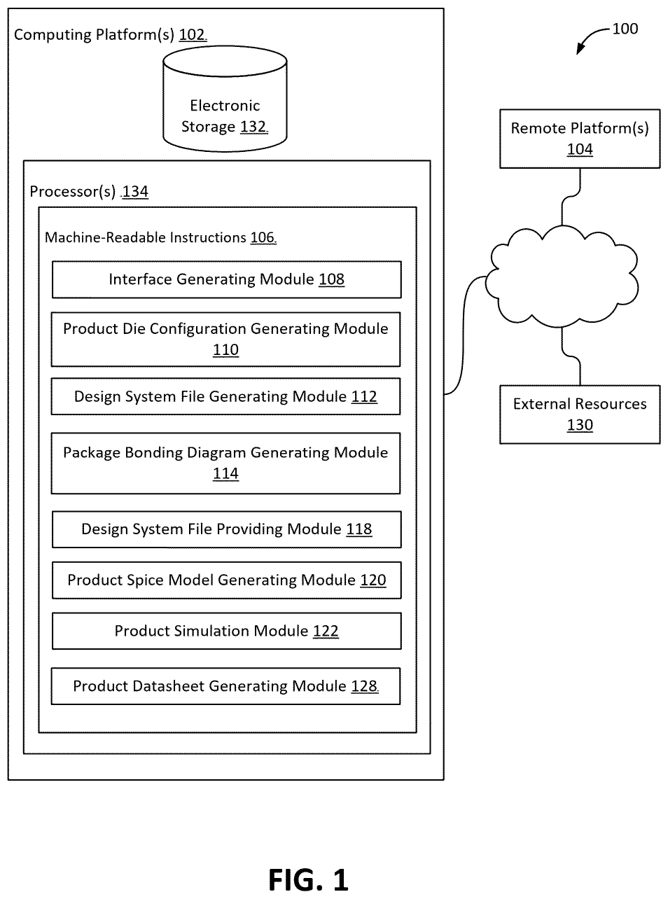

FIG. 1 illustrates a system 100 configured for designing a discrete device product, in accordance with one or more implementations. As used herein, a discrete device is a device that is not a microprocessor but is a combination of one or more electronic devices such as, by non-limiting example, a power semiconductor device, a diode, a transistor, a metal oxide field effect transistor (MOSFET), a rectifier, an active component, a passive component, or any other electronic device type, whether in the form of a bare die or a die incorporated in a package. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104. Examples of remote platforms 104 that may be used by users include, by nonliving example, desktop computers, server computers, laptop computers, smart phones, tablets, or any other portable electronic device.

Computing platform(s) 102 may be configured by machine-readable instructions 106. Machine-readable instructions 106 may include one or more instruction modules. The instruction modules may include computer program modules. The instruction modules may include one or more of interface generating module 108, product generating module 110, design system file generating module 112, package bonding diagram generating module 114, design system file providing module 118, product SPICE model generating module 120, product SPICE model providing module 122, product datasheet generating module 128, and/or other instruction modules.

Interface generating module 108 is designed to generate a first interface and receive from a user a selection of at least one die and at least one test condition. The die may be selected from at least one technology type, or semiconductor processing flow type used to make the die. In various implementations where the discrete product includes both a die and a package, the first interface may allow the user to select a package type as well. Examples of the first interface will be further described in this document. In the first interface however, a wide variety of product related items may be selected, such as, by non-limiting example, device voltage rating, die width, die height, width the scribe line, width of the gate pad, height of gate pad, number of internal gate runners, location of the gate on a die, die thickness, source metal resistance, lead frame type, gate wire material, gate wire diameter, number of gate wires, source wire material, source wire diameter, number of source wires, emitter wire material, emitter wire diameter, number of source wires, number of emitter wires, single wire stitching, double wire stitching, anode wire material, anode wire diameter, number of anode wires, kelvin wire material, kelvin wire diameter, number of kelvin wires, any combination thereof, and any other die or package parameter. Examples of test conditions that may be selected using the first interface may include, by non-limiting example, varying temperature levels, current at which the threshold voltage is measured, currents at which the RDSₒₙ or VCEₛₐₜ are measured, capacitance values, voltage for capacitance and gate charge, drain current, collector current, drain voltage, collector voltage, switching tests type, load voltage used for resistive and/or inductive switching, external gate resistance used for resistive and/or inductive switching, any combination thereof, and any other desired test parameter. Interface generating module 108 is also designed to generate a second interface and provide access to graphic design system files created by the system. The graphic design system file (GDS file) includes the die layout image and detailed layer geometry file which is used for mask making and further manufacturing steps. By way of non-limiting example, the user may have access to the graphic design system file, the package bonding diagram, the product SPICE model, and the product datasheet through the second interface. The product datasheet may be an initial one or may be a fully finalized product datasheet ready for distribution to customers in various implementations.

While the use of a first interface to select information relating to the discrete product to be developed is disclosed in this document, in particular implementations, a first interface may simply include an interface sufficient to upload a file that contains the desired information. The format of the file being uploaded may be, by non-limiting example, American Standard Code for Information Interchange (ASCII), xml, Java Script Object Notation (JSON), flat file, text file, binary file, or any other file format. In some implementations, the first interface may be implemented using a LINUX terminal session window where the file is selected at the command line and the various modules and methods implemented are implemented in a batch processing mode using the file. In other implementations, a command entered at a command line may bring up a graphical user interface used to select the file and implement the various modules and methods in a batch processing mode using the file. In other implementations, the first interface may be generated using a standalone graphical user interface (form window) generated by the computing system that allows for selecting of the file and execution of the various modules and methods in batch mode. In still other implementations, the first interface may be generated by a web browser or web application with the computing system which allows the user to select the file and then begin execution of the various modules and methods in batch mode. A wide variety of computer interfaces may be employed that allow for batch execution of the various modules and methods disclosed herein using a file.

Product generating module 110 is configured to generate, using a processor, a product die configuration and a product package configuration using a predictive modeling module and the at least one die and the package type if a package type was selected. The predictive modeling module includes a back propagated model and the back propagated model is used to predict one or more electrical performance parameters of the discrete device product. Based on the electrical performance parameter(s) the predictive modeling module and back propagated model are also able to, where a package type was selected, determine package size as well as determine die size, and or die characteristic information in various implementations. By way of non-limiting example, the predictive modeling module may include a back propagated model and the back propagated model is used to predict a die dimension, gate pad location, or gate runner based on desired electrical/performance characteristics for the product (Rdsₒₙ, etc.). The predictive modeling module may include a back propagated model generated by fitting data collected from previous discrete device products. The predictive modeling module may include a back propagated module generated by/from a previously generated scalable product SPICE model like those disclosed herein. By scalable is meant a SPICE model that comprehends changes in electrical, thermal, and/or magnetic performance of the discrete device product due to changes in die and/or package parameters. In various implementations the discrete device products would include either the same type of product being designed, related discrete products, or all products being designed. As used herein, “product” means at least one die and, where a package is included, a corresponding package which is ultimately marketed under a specific part number by a semiconductor device manufacturer. In various implementations, the back propagated model generated by fitting data from measurements or previously generated scalable SPICE models may be created by performing various statistical operations for the various die in packages that are included in the products being compared. In some implementations, data transforms for the data being considered in the model may be utilized. The data transform may be used in normalize the data in such a way that it can be fitted using a regression or other statistical analysis.

In other system implementations, however, the back propagated model may not rely on any statistical analysis of prior products when generating scalable SPICE models. Instead, the use of deep learning/machine learning techniques may be used to develop functions that allow for optimization of particular electrical parameters for the package and/or die. The use of deep learning/machine learning techniques may allow the back propagated model to handle situations beyond the scope of any particular data set and may be helpful in situations where new products are being proposed for the first time. The predictive modeling module may include a back propagated model generated by a neural network trained using data from previous discrete device products.

A wide variety of deep learning solutions may be employed in various supplementations. By deep learning is meant the use of at least 3 layers of densely connected neurons. A wide variety of machine learning techniques have may be utilized to help the network learn including, by non-limiting example, drop out, batch size, stochastic gradient descent, forward propagation, backward propagation, the number of hidden layers, the number of neurons, gradient descent, cross entropy cost, and any other machine learning technique for refining the network. By way of non-limiting example, the neural network in particular and limitations may include two input neurons, three densely connected hidden layers including rectified linear network unit neurons, and an output layer of linearly activated neurons. However, more layers and more neurons or fewer layers and fewer neurons may be used in other limitations.

In various implementations, various die parameters selected by the user in the first interface may affect the electrical/process conditions of the die itself. By non-limiting example, the user may select a particular value for die thickness, normalized peak channel doping, normalized gate oxide thickness, or any other die parameter that affects the electrical/process performance of the die. In various system and method implementations, the system may adjust the scalable SPICE model to correspond with the selected values. Also, in various system and method implementations, the system may adjust a die SPICE model itself to comprehend the effects of the values and continue the various method steps using the various modules disclosed herein. In various implementations, the effects of the various values for the die parameters may be accounted for using, by non-limiting example, a correlation, a look up table, a derived mathematical relationship, a back propagated model, or any other method or system for adjusting SPICE model parameters for a die.

In various system implementations, the first interface may include components that allow the user to select various variation limits for one, any, or all of the electrical parameters associated with the die and/or package. By non-limiting example, these variation limits may be set using the interface to select a minimum or a maximum allowed amount of variation for a particular parameter. In the interface, this selection may be done using a checkbox element. In various implementations, these variation limits may be referred to as corner limits. Non-limiting examples of electrical parameters that may employ corner limits may be threshold voltage (Vth), RDSon, capacitance, or Qg or any other or any other electrical parameter of the package in various system and method implementations. During system operation, the corner limits are used in the formation of the scalable SPICE model as the system simulates the corner limits by adjusting internal process parameters in the SPICE model(s) used by the system to create the scalable SPICE model. The resulting scalable SPICE model's ability to predict product performance is accordingly extended within the range of the corner limits. This adjusted scalable SPICE model then can be used by the product simulation model as described hereafter to provide datasheet characteristics that show typical performance as well as performance according to the amount of particular corner limit for a given electrical parameter. These datasheet characteristics can then be included in a datasheet associated with the discrete device product using the processes and systems disclosed hereafter.

Design system generating module 112 may be configured to generate, using a processor, a graphic design system file (GDS file) using a graphic design system module with the product die configuration and the product package configuration. The graphic design system module may use a native parameterized layout cell (PCELL). Where the graphic design system module uses a native PCELL, the settlor includes the full technology device design, layers, and corresponding design rules. The graphic design system module may use a generic PCELL. Where the graphic design system module uses a generic PCELL, the sole only contains the top-level layers of the device that include, by non-limiting example, metal, passivation, or other boundary materials. In either case, in a particular implementation, the graphic design system file is generated by invoking the software marketed under the tradename CADENCE by Cadence Design Systems of San Jose, California, and the native PCELL or generic PCELL in batch mode. Many other software products could be used, however, that include PCELLS as part of the development process.

Package bonding generating module 114 generates, using a processor, a package bonding diagram using a build diagram system module with the graphic design system file. In particular implementations, the package bonding generating module 114 may generate the bonding diagram by invoking a particular tool in batch mode using the generated graphic design system file as an input. By way of non-limiting example, the build diagram system module may utilize any of the die and/or package parameters selected that were previously disclosed. In particular and limitations, these parameters may include package type, package lead frame, number of gate runners, gate position, wire type, wire stitching type, number of source wires, die attach material, or a virtual clip to generate the package bonding diagram.

With respect to the use of a virtual clip, ordinarily, clip type, shape, and structure are selected from a library of previously physically manufactured and tested clip designs. A challenge with modeling a discrete product like those disclosed herein is that the clip designs available in the library simply are not numerous enough to be able to correspond with all of the possible combinations of die size, gate pad position, package size, etc. that could be encountered/considered by a user designing the discrete product. In order to enable the creation of scalable SPICE models for the die and/or package, the use of virtual clips whose sizes, materials, and coverage of the die are determined using various predetermined parameters may be utilized in various implementations. For example, a virtual clip may be selected by the user for inclusion in a particular product design using the first interface and the various system modules (predictive modeling module, build diagram system module, or package bonding generating module in various implementations) may then calculate the shape of an ideal clip for the particular dimensions of the die that was selected by the user. If the user then changes the size of the die (either manually or automatically through input/output of the predictive modeling module), the system then correspondingly resizes the clip. In various implementations, the system may determine the size of the clip using, by non-limiting example, a correlation between clip size and die size (rectangular, etc.), a maximum die coverage model, machine learning, statistical modeling, or any other factors affecting clip performance. In various virtual clip implementations, additional factors may be taken into account to attempt to ensure that the virtual clip as closely approximates the performance of the actual physical clip when the physical clip is made. These additional factors may include, in various implementations, a clip percent coverage reduction factor designed to reduce the coverage of the die by the clip by a percentage intended to mimic non-uniformities in a physical clip, such as but not limited to openings or holes in the clip needed in real life for mechanical/bonding considerations. These factors may also include, by non-limiting example, clip thickness, which allows the system to alter the thickness of the clip to reflect what the actual real world mechanical design of the particular clip may require. The goal of the virtual clip and the various factors is to closely enough approximate the physical and electrical performance of the actual physical clip to ensure the scalable SPICE models developed for the die and/or package create a design that reflects the ultimate electrical/thermal/magnetic performance of the discrete product. The use of virtual clips in various implementations may be an enabler that permits the system to carry out effective modeling of the discrete products so that the results correlate with the actual physical builds.

Once the virtual clip's dimensions have been determined, the package bonding generating module 114 utilizes it for the purposes of developing the bonding diagram. The virtual clip may then be taken to an external vendor for production after the package design is completed. The package bonding generating module 114 may additionally consider other factors including, by non-limiting example, gate restrictions, die rotation, ribbon bonding, stitching orientation, multi-die packages, and any other parameter relevant to die attach, package structure, or die bonding.

Initially, the die SPICE models used in the system are selected by selecting the die technology type and package SPICE models are selected by selecting the package technology/type from which the product will be built. These die SPICE models and package SPICE models are then used to generate a composite scalable SPICE model. The die SPICE models or the package SPICE models may be those that have been previously developed/derived during the process development cycle for use in the discrete product development system.

Design system file providing module 118 may be configured to provide, using a processor, the graphic design system file, the package bonding diagram, and the die SPICE model parameters (and package SPICE model parameters, if a package was selected) to the product SPICE model generating module. Product SPICE model generating module 120 then generates, using a processor, a product SPICE model of the discrete device product using the die and package parameters and the scalable SPICE model for the die and scalable SPICE model for the package (if a package was selected). The product SPICE model generating module may also use a wide variety of computer aided modeling techniques to create the product spice model such as, by non-limiting example, a finite element modeling process, electrical simulations, deep learning techniques, neural networks, engineering calculations numerical methods, any combination of the foregoing, and any other engineering modeling technique capable of creating parameters that can be included in a SPICE model. The resulting product SPICE model is generated with a SPICE agnostic syntax such that any commercial SPICE simulator can be supported. Non-limiting example of commercial SPICE simulators may include the simulator marketed under the tradename PSPICE by Cadence Design Systems; the simulator marketed under the tradename LTSPICE by Analog Devices of Norwood Massachusetts; the simulator marketed under the tradename HSPICE by Synopsys, Inc. of Mountain View, California; the simulator marketed under the tradename ELDO by Mentor Graphics of Wilsonville, Oregon; the simulator marketed under the tradename SIMETRIX by SIMetrix Technologies LTD of Berkshire, UK; the simulator marketed under the tradename SPECTRE by Cadence Design Systems; the simulator marketed under the tradename ADS by Keysight Technologies Inc. of Santa Rosa, California; the simulator marketed under the tradename SABER by Synopsys, Inc.; the simulator marketed under the tradename SIMPLORER by Ansys, Inc. of Canonsburg, Pennsylvania; or the simulator marketed under the tradename MICROCAP by Spectrum Software.

The product SPICE model may be transmitted for inclusion in a database of die or package SPICE models for later selection by a user. In various implementations, a package SPICE model included in the product SPICE model may be provided to a technology computer aided design (TCAD) module during mixed mode, capacitance, current-voltage, or other simulations that involve both finite element analysis and SPICE elements and analysis to enable the TCAD module to carry out such simulations. The output of the TCAD module can be stored in a database of that can be subsequently used by the system to generate new product SPICE models and further SPICE product models, using the methods disclosed herein

In various implementations, product simulation module 122 receives, using a processor, the product SPICE model. The product simulation module 122 then uses the product SPICE model and the at least one test conditions specified to generate a set of data sheet characteristics for the product. In particular implementations the product simulation module may utilize any of the simulation software products disclosed in this document to conduct the simulations. Product simulation module 122 generates, using a processor, one or more datasheet characteristics of the discrete device product with the product SPICE model. By way of non-limiting example, the one or more datasheet characteristics may include maximum rating, thermal characteristics, package outline, current-voltage characteristics, capacitance and gate charge characteristics, dynamic switching and reverse recovery characteristics, safe operating area characteristics or any other desired discrete product parameter desired for inclusion in a datasheet. By way of non-limiting example, the one or more datasheet characteristics may include a product performance graph, a product performance table, a product pinout, a package outline, or a product specification.

Product simulation module 122 then provides, using a processor, the one or more datasheet characteristics to a datasheet formation module 128. Product datasheet generating module 128 generates, using a processor, a product datasheet for the discrete device product using the graphic design system file, the package bonding diagram, and the one or more datasheet characteristics. The product datasheet may be automatically submitted for inclusion in a product datasheet database. In various implementations the datasheet formation module 128 employs the document preparation system marketed the tradename LATEX by The LATEX Project. However, in other implementations, the data sheet formation module 128 may use many other document preparation systems, data formats, typefaces, and fonts as desired to generate datasheet. Once the product datasheet has been generated, the second interface is used to provide access for the user to the graphic design system file, the package bonding diagram, the product SPICE model, and the product datasheet as will be described hereafter.

In various implementations, the use of the product simulation module and datasheet formation module may not be used during at least an initial phase of design. In such implementations, the system may be used iteratively by the user to find a die size and/or package size that can provide a desired electrical/performance characteristics with each simulation run taking seconds. Once the die size and/or package size has been identified, the user may then indicate (either through selecting a different mode of operation or selecting each module individually) that the product simulation module and datasheet formation module are to participate in the simulation flow of the system. In such implementations, this may allow the user to speed the process of finding key product parameters up front and then allow for in depth verification/checking of the full electrical/thermal performance of the product design afterward with the product simulation module and datasheet formation module. In various implementations, the first interface may have an indicator button or other selector to allow the user to leave out or include the product simulation module and datasheet formation module in the simulation process/flow.

In some implementations, computing platform(s) 102, remote platform(s) 104, and/or external resources 130 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 130 may be operatively linked via some other communication media.

A given remote platform 104 may include one or more processors configured to execute computer program modules. The computer program modules may be configured to enable an expert or user associated with the given remote platform 104 to interface with system 100 and/or external resources 130, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 130 may include sources of information outside of system 100, external entities participating with system 100, and/or other resources. In some implementations, some or all of the functionality attributed herein to external resources 130 may be provided by resources included in system 100.

Computing platform(s) 102 may include electronic storage 132, one or more processors 134, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 132 may include non-transitory storage media that electronically stores information. The electronic storage media of electronic storage 132 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 132 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 132 may include one or more virtual storage resources (e.g., cloud storage, a virtual private network, and/or other virtual storage resources). Electronic storage 132 may store software algorithms, information determined by processor(s) 134, information received from computing platform(s) 102, information received from remote platform(s) 104, and/or other information that enables computing platform(s) 102 to function as described herein.

Processor(s) 134 may be configured to provide information processing capabilities in computing platform(s) 102. As such, processor(s) 134 may include one or more of a digital processor, an analog processor, a digital circuit designed to process information, an analog circuit designed to process information, a state machine, and/or other mechanisms for electronically processing information. Although processor(s) 134 is shown in FIG. 1 as a single entity, this is for illustrative purposes only. In some implementations, processor(s) 134 may include a plurality of processing units. These processing units may be physically located within the same device, or processor(s) 134 may represent processing functionality of a plurality of devices operating in coordination. Processor(s) 134 may be configured to execute modules 108, 110, 112, 114, 118, 120, 122, and/or 128, and/or other modules. Processor(s) 134 may be configured to execute modules 108, 110, 112, 114, 118, 120, 122, and/or 128, and/or other modules by software; hardware; firmware; some combination of software, hardware, and/or firmware; and/or other mechanisms for configuring processing capabilities on processor(s) 134. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 118, 120, 122, and/or 128 are illustrated in FIG. 1 as being implemented within a single processing unit, in implementations in which processor(s) 134 includes multiple processing units, one or more of modules 108, 110, 112, 114, 118, 120, 122, and/or 128 may be implemented remotely from the other modules. The description of the functionality provided by the different modules 108, 110, 112, 114, 118, 120, 122, and/or 128 described below is for illustrative purposes, and is not intended to be limiting, as any of modules 108, 110, 112, 114, 118, 120, 122, and/or 128 may provide more or less functionality than is described. For example, one or more of modules 108, 110, 112, 114, 118, 120, 122, and/or 128 may be eliminated, and some or all of its functionality may be provided by other ones of modules 108, 110, 112, 114, 118, 120, 122, and/or 128. As another example, processor(s) 134 may be configured to execute one or more additional modules that may perform some or all of the functionality attributed below to one of modules 108, 110, 112, 114, 118, 120, 122, and/or 128.

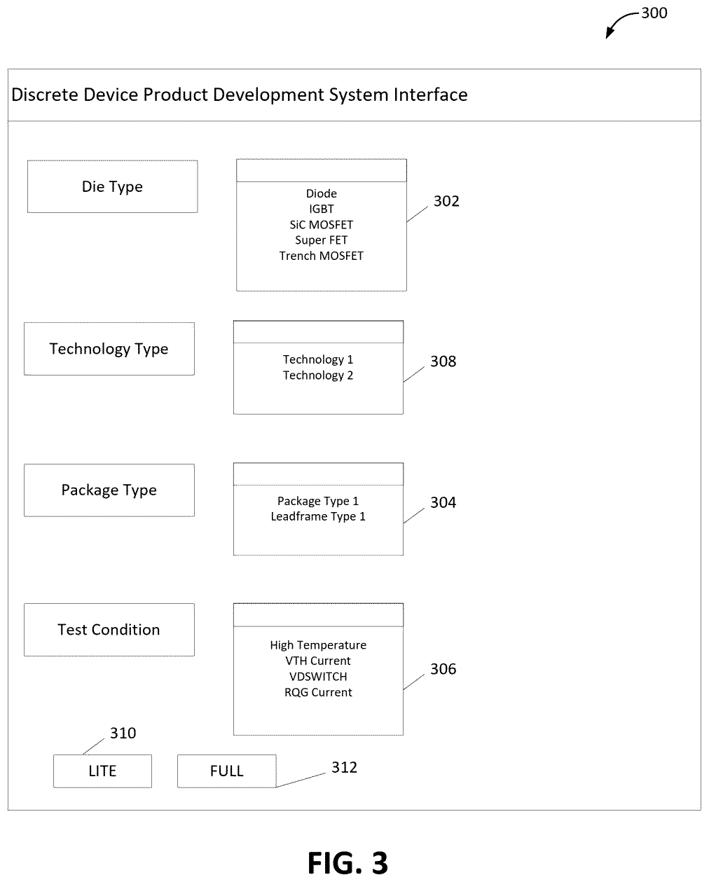

Referring to FIG. 3, an implementation of a first interface or product data entry interface 300 is illustrated. As illustrated, in this implementation, the interface 300 includes a die type drop down 302 that allows the user to select between different die/device types. Also as illustrated, interface 300 includes a package type drop down 304 which allows the user to select between different package types, lead frame types, or package and lead frame types. As illustrated, the interface 300 includes a technology drop down 308 that allows the user to select a technology type either for the die, the package, or both the die or package. As illustrated, the interface 300 also includes a test condition drop down 306 which is designed to allow the user to select one or more test parameters for use by the product simulation module later in the process flow. While the use of drop-down menus has been illustrated in the interface implementation 300 illustrated in FIG. 3, radio buttons or other control types may be used in other interface applications. Also as illustrated, the interface 300 includes a button 310 that allows the user to execute a simulation run that does not include the product simulation module and datasheet generating module (LITE) and a button 312 that allows the user to execute a simulation run that does include all of the modules in the flow (FULL).

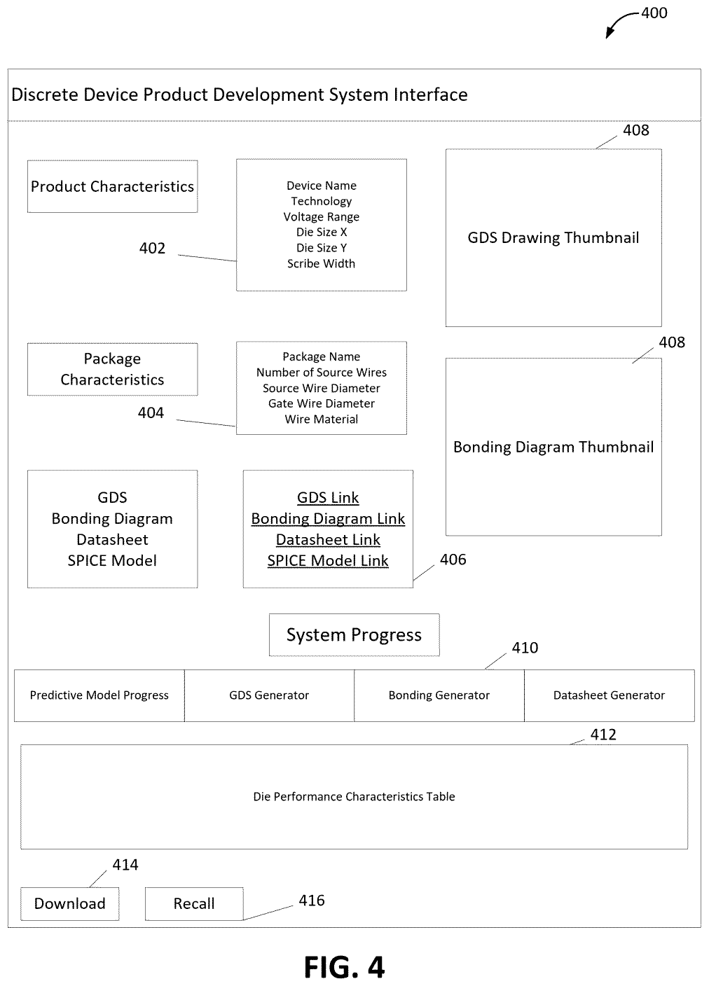

Referring to FIG. 4, an implementation of an output interface 400 is illustrated. In the output interface 400 the output of the various modules is displayed. For example, in the interface implementation 400 illustrated, various product characteristics 402 of the product that has been designed are illustrated in the interface. As illustrated, these product characteristics can include the name of the device, the technology, the voltage range of the device, the die size in X, the die size in Y, the scribe width, or any other desired product characteristic. In another portion of the interface 400 various package characteristics 404 may be included. As illustrated, these package characteristics may include the package name, number of source wires, source wire diameter, gate wire diameter, wire material, or any other characteristic of the package. The interface 400 also includes a section where that user can access via various links the graphics design system file, the bonding diagram, the data sheet, and the product SPICE model. The product SPICE model may be provided in encrypted and unencrypted form in various implementations and may be provided to be executable using any of the simulator types disclosed herein. Also included in various implementations may be a system progress report 410 which allows the user to see though color coding the progress of the system through predictive modeling, graphic design system file generation, bonding diagram generation, data sheet generation, and any other system module. In various implementations, the system may be able to show the user via the system progress report 410 whether any one of the modules encountered a fault so that the user can then take appropriate action. In very simple notations the fault may be by changing the color surrounding the text of the appropriate module from green to red or to any other desired color.

Referring to FIG. 4, following the completion of the output of the various modules, a die performance characteristics table 412 may be included in various interface implementations. In various interface implementations a Download button 414 may be included which may allow the user to download a file that contains the various die performance characteristics in various file formats which may be any disclosed in this document. Also in various implementations, a Recall button 416 may be used to allow the user to take the calculated die size, package characteristics, die performance characteristics, or any other calculated parameter from the output of the various modules and transfer them to a new version of the first interface for future and/or iterative processing by the user.

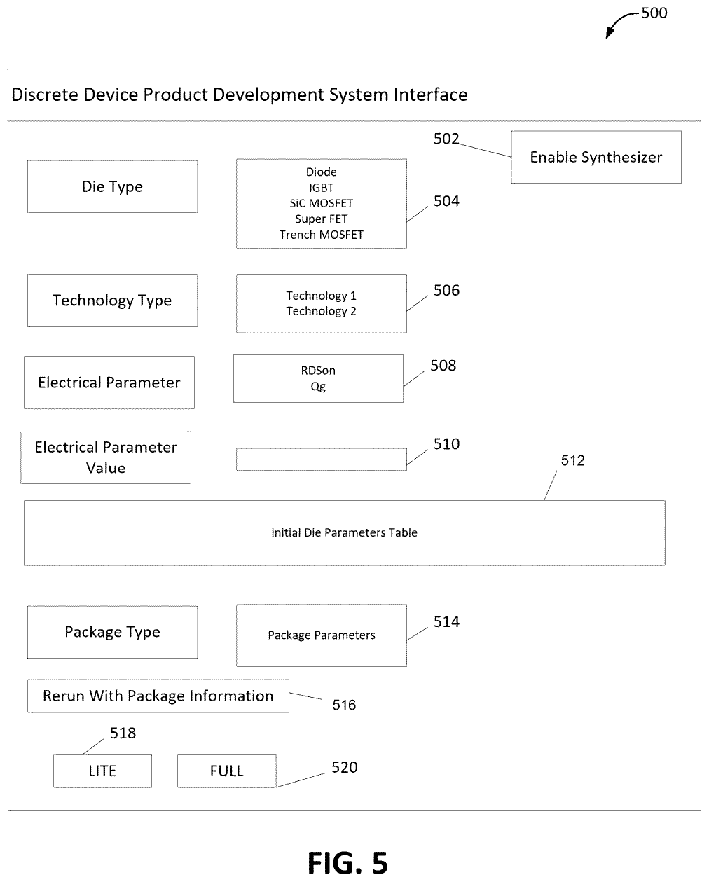

Referring to FIG. 5, a second implementation of a first interface 500 is illustrated. In this implementation the user may select a die type using a die type selection dialog 504, and a technology type using technology type selection dialog 506. At this point the user then enters the particular electrical parameter(s) desired for the die and/or package optimization, in this case RDSon or Qg. Once the electrical parameter type has been selected via the electrical parameter dialog 508, the user enters the desired value of the electrical parameter in dialog 510. The user then presses the Enable Synthesizer button 502 to begin the work of the predictive modeling module with the die, technology, and electrical parameter information. In various implementations the predictive modeling module may be any disclosed in this document and may use any method of predictive modeling disclosed in this document. This includes using a back propagated model using fitted data, a back propagated model generated by a neural network, or a scalable SPICE model. Following work by the predictive modeling module, the interface may be updated to include a set of initial die parameters in the form of initial die parameters table 512. These initial die parameters are those calculated to meet the particular electrical parameter value entered by the user. For example if the electrical parameter was RDSon, the goal of the predictive modeling module would be to find the smallest die area possible that would yield a device that produces the entered value for RDSon.

Following simulation, if the product is a bare die, then these initial die parameters are those desired by the user as calculated by the predictive modeling module. However in those implementations where the system is being asked to model a discrete device product that includes both a die and the package, the predictive modeling module needs to take the electrical/thermal/magnetic effects of the package into account to design a product that meets the desired electrical parameter value. In such implementations, the user then uses package parameters dialog 514. These package parameters may be any disclosed in this document for a package. Following entry of the package type and package parameters the user may then presses the Rerun With Package Information button 516 to send the package information to the predictive modeling module. In various implementations, the predictive modeling module uses a scalable SPICE model for the package like those disclosed herein in its calculations with the existing previously calculated initial die parameters to then recalculate the die parameters needed to meet the electrical parameter value target entered by the user. The initial die parameters table 512 then may be updated with the newly calculated die parameters. For example, the effect of adding the package may result in increasing die size from the originally calculated die size to enable the resulting product to reach the desired RDSon target.

At this point, the user may then select the LITE button 518 or the FULL button 520 to carry out the work of the remaining modules disclosed in the system. In various implementations, the LITE button 518 may carry out the various simulation activities without producing a datasheet as previously disclosed in this document. In various implementations, the full button 520 may be used to carry out the various simulation activities and also generate a datasheet as previously disclosed in this document. Also in various implementations a recall button could be used to send die parameters, technology parameters, and/or electrical parameters to this implementation of the first interface 500 as disclosed in this document.

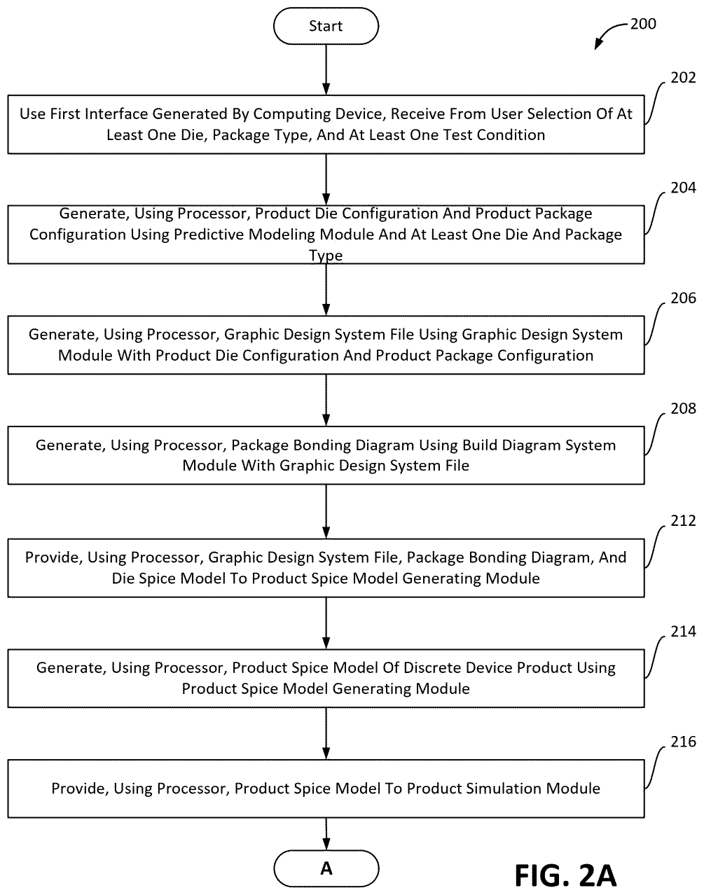

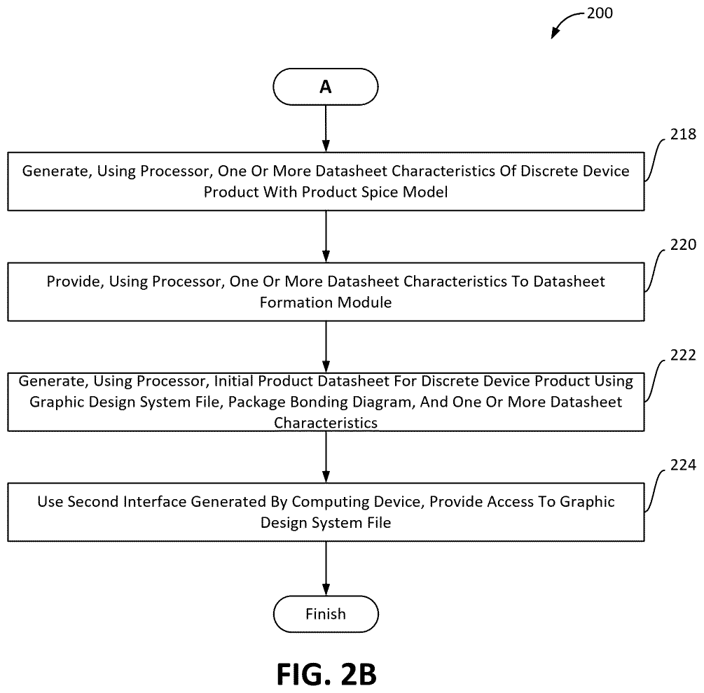

FIGS. 2A and 2B illustrate an implementation of a method 200 for designing a discrete device product, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 includes, using a first interface generated by a computing device, receiving from a user a selection of at least one die, a package type (if a package is to be selected), and at least one test condition. Operation 202 may be performed by one or more hardware processors configured by machine-readable instructions including a module that is the same as or similar to interface using module 108, in accordance with one or more implementations. In various implementations the first interface may resemble interface 300 of FIG. 3.

An operation 204 includes generating, using a processor, a product die configuration (and a product package configuration, if a package was selected) using a predictive modeling module and the at least one die and the package type. Operation 204 may be performed by one or more hardware processors configured by machine-readable instructions including a module that is the same as or similar to product generating module 110, in accordance with one or more implementations. Any of the model types disclosed herein may be employed in the generation process.

An operation 206 includes generating, using a processor, a graphic design system file using a graphic design system module with the product die configuration (and the product package configuration if a package was selected). Operation 206 may be performed by one or more hardware processors configured by machine-readable instructions including a module that is the same as or similar to design system generating module 112, in accordance with one or more implementations.

An operation 208 includes generating, using a processor, a package bonding diagram using a build diagram system module with the graphic design system file. Operation 208 may be performed by one or more hardware processors configured by machine-readable instructions including a module that is the same as or similar to package bonding generating module 114, in accordance with one or more implementations.

An operation 212 includes providing, using a processor, the graphic design system file, the package bonding diagram (if a package was selected), and a die SPICE model (along with a package SPICE model if a package was selected) to a product SPICE model generating module. Operation 212 may be performed by one or more hardware processors configured by machine-readable instructions including a module that is the same as or similar to design system file providing module 118, in accordance with one or more implementations.

An operation 214 includes generating, using a processor, a product SPICE model of the discrete device product using the product SPICE model generating module. Operation 214 may be performed by one or more hardware processors configured by machine-readable instructions including a module that is the same as or similar to product SPICE model generating module 120, in accordance with one or more implementations.

An operation 216 includes providing, using a processor, the product SPICE model to a product simulation module. Operation 216 may be performed by one or more hardware processors configured by machine-readable instructions including a module that is the same as or similar to product simulation module 122, in accordance with one or more implementations.

An operation 218 includes generating, using a processor, one or more datasheet characteristics of the discrete device product with the product SPICE model and the product simulation module 122. Operation 218 may be performed by one or more hardware processors configured by machine-readable instructions including a module that is the same as or similar to product simulation module 122, in accordance with one or more implementations.

An operation 220 includes providing, using a processor, the one or more datasheet characteristics to a datasheet formation module 128. Operation 220 may be performed by one or more hardware processors configured by machine-readable instructions including a module that is the same as or similar to datasheet characteristic formation module 128 or product simulation module 122, in accordance with one or more implementations.

An operation 222 includes generating, using a processor, a product datasheet for the discrete device product using the graphic design system file, the package bonding diagram, and the one or more datasheet characteristics. Operation 222 may be performed by one or more hardware processors configured by machine-readable instructions including a module that is the same as or similar to product datasheet generating module 128, in accordance with one or more implementations.

An operation 224 includes using a second interface generated by a computing device, providing access to the graphic design system file. Access to the package bonding diagram, the package SPICE model, and the product datasheet are provided to the user via the second interface. Operation 224 may be performed by one or more hardware processors configured by machine-readable instructions including a module that is the same as or similar to interface generating module 108, in accordance with one or more implementations. This interface may look, and various implementations, like the interface illustrated in FIG. 4.

The various system and method implementations herein utilize product SPICE models that are constructed using simulations carried out that integrate a semiconductor die with a corresponding package (semiconductor package). These product SPICE models correspond with a particular product sold by a semiconductor product manufacturer that a circuit designer wants to incorporate into a particular system design. The system being designed may be a circuit board or motherboard that uses the semiconductor product as a component or for which the entire circuit board or motherboard is designed for. Semiconductor products ordinarily are sold in association with a datasheet that contains electrical performance, electrical characteristics, and package configuration information (pin out, etc.) that the circuit designer needs to know in order to incorporate the semiconductor product into the board design properly.

Circuit designers utilize system level simulators that simulate the semiconductor product as part of determining the entire system's electrical performance/characteristics. In the case of power semiconductor systems, the system level simulators allow the circuit designer to simulate the electrical power characteristics of the system/device being designed. In the case of a power converter device, the system level simulator permits the simulation of various power converter topologies. The system level simulators take as an input a product system file for the particular semiconductor product that includes models of conduction losses, switching energy losses, and thermal impedance data. Ordinarily, the data for these models comes from data on a datasheet for the semiconductor product which was obtained by physically testing an as-assembled semiconductor product in a lab set up. The challenge with the datasheet data obtained in this ways is that the loss-related data is dependent on the parasitics of the lab measurement set up and of the parasitics of the lab testing circuit(s). Furthermore, the data collected in the lab is not often dense enough to ensure accurate interpolation/extrapolation for the semiconductor product. Indeed, the quantity of data available creates a situation where significant extrapolation with insufficient data points is required by the system level simulator. Furthermore, the lab testing process marginalities affect/bias the simulation results and cannot be corrected for/estimated because the only data available includes all the lab set up errors. The foregoing create situations where overdesign, underdesign, or marginal design can occur simply because the circuit designer is working with inaccurate information about the semiconductor product's actual performance when actually installed in the actual system. This can result in prototype and field failures and can greatly increase the time and expense associated with doing the circuit/board design.

Another way of looking at the issues created during lab measurements is that the potential unknowns created by the particular lab setup(s) used to obtain datasheet data become one of what can be an infinite quantity of boundary conditions that are statistically unlikely to line up with the particular boundary conditions a circuit designer who designed the semiconductor product with. Since the parasitics of the lab setup (and other factors associated with temporary testing of a part) add additional variation, this variation winds up reducing the likelihood that the lab test result results accurately reflect the actual real-world performance of the part consistent with what the designer intended.

The product SPICE models for the semiconductor products disclosed herein are derived through modeling carried out using either or both of the modeling processes disclosed in U.S. Pat. No. 11,481,532 to Victory et al., “Systems and Methods for Designing a Discrete Device Product,” issued Oct. 25, 2022 ('522 Patent), and U.S. Pat. No. 11,481,533 to Victory et al., “Systems and Methods for Designing a Module Semiconductor Product,” issued Oct. 25, 2022 ('533 Patent), the disclosures of each of which are incorporated entirely herein by reference. The term “product SPICE model” as used herein thus means the same as the corresponding “product SPICE model” as used in each of the '532 and '533 Patents. These product SPICE models are the result of significant simulations that take into account the electrical/thermal characteristics of one or more semiconductor die and the electrical/thermal characteristics of the corresponding packaging to which the one or more semiconductor die are coupled and which are used to provide electrical/thermal connections to a circuit or motherboard to which the semiconductor product is coupled. Because of this, these product SPICE models are unlike the datasheet data provided using the ordinary lab testing process as these models, as models, do not include any of the losses/error caused by the lab equipment or test circuitry. Furthermore, the product SPICE models, as mathematically-based models, have the ability to be “tested” using a much more granular/numerous amount of inputs supplied to the product SPICE models with a corresponding ability to output a correspondingly more granular/number of outputs. Furthermore, the use of the product SPICE models for testing allows the circuit designer to apply the designer's boundary conditions to the product to get system data that matches the designer's boundary condition (without having to deal with additional unknown boundary conditions introduced through the lab testing set up). Finally, the system and method implementations disclosed herein allow the designer to take into account various parasitics associated with the circuit of the designer's system itself, which is simply not measurable/adjustable using ordinary lab testing setups.

The various system and method implementations disclosed herein utilize product SPICE models like those disclosed in the '532 and '533 Patents to create product system model files that can be used by various system level simulators used by circuit designers during circuit design. These product system model files may take the format of a structured text file, a plain text file, or a delimited text file in various implementations. In some implementations, the product system model file may be a structured text file in an xml format that is structured for use in a Piecewise Linear Electrical Circuit Simulation (PLECS) system level simulator (a PLECS model) marketed by Plexim of Zurich, Switzerland. In other implementations, the product system file may be a structured text, plain text or a delimited text file capable of being utilized in another system level simulator type like the one marketed under the tradename PSIM by Powersim, Inc. of Rockville, MD, or any other system level simulator.

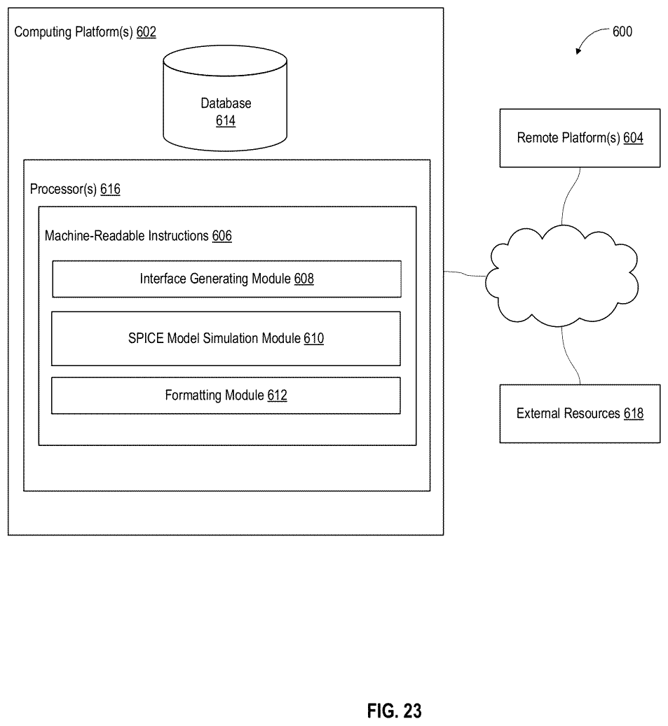

Referring to FIG. 23, a block diagram of an implementation of a system 600 for generating a system model for using in system level simulations is illustrated. In some implementations, system 600 may include one or more computing platforms 602. Computing platform(s) 602 may be configured to communicate with one or more remote platforms 604 according to a client/server architecture, a peer-to-peer architecture, and/or other architectures. Remote platform(s) 604 may be configured to communicate with other remote platforms via computing platform(s) 602 and/or according to a client/server architecture, a peer-to-peer architecture, and/or other architectures. Users may access system 600 via remote platform(s) 604. Examples of remote platforms 604 that may be used by users include, by nonliving example, desktop computers, server computers, laptop computers, smart phones, tablets, or any other portable electronic device.

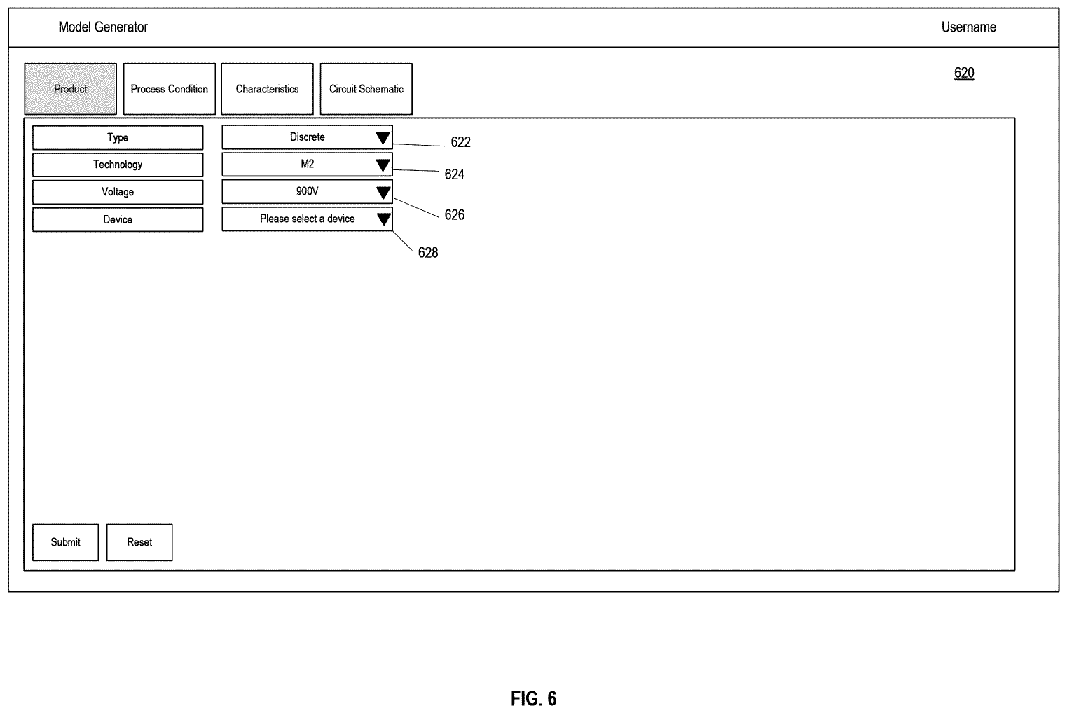

Computing platform(s) 602 may be configured by machine-readable instructions 606. Machine-readable instructions 606 may include one or more instruction modules. The instruction modules may include computer program modules. The instruction modules may include one or more of an interface generating module 608, a SPICE model simulation module 610, and a formatting module 612. Interface generating module 608 works to generate the various computing interfaces illustrated in FIGS. 6-9 which will be described in more detail hereafter. SPICE model simulation module 610 carries out a series of simulations using a product SPICE model selected by the user that is stored in database 614 which contains a set of product SPICE models like those disclosed in the '532 and '533 Patents. The results of those simulations are then processed by formatting module 612 to form a product system model file. In various implementations, the product system model file may be stored in the database 614 for retrieval by the user or others who wish to access the file.

In some implementations, computing platform(s) 602, remote platform(s) 604, and/or external resources 618 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 602, remote platform(s) 604, and/or external resources 618 may be operatively linked via some other communication media.

A given remote platform 604 may include one or more processors 616 configured to execute computer program modules. The computer program modules may be configured to enable an expert or user associated with the given remote platform 604 to interface with system 600 and/or external resources 618, and/or provide other functionality attributed herein to remote platform(s) 604. By way of non-limiting example, a given remote platform 604 and/or a given computing platform 602 may include one or more of a server, a desktop computer, a laptop computer, a handheld computer, a tablet computing platform, a NetBook, a Smartphone, a gaming console, and/or other computing platforms.

External resources 618 may include sources of information outside of system 600, external entities participating with system 600, and/or other resources. In some implementations, some or all of the functionality attributed herein to external resources 618 may be provided by resources included in system 600. As illustrated in FIG. 23, computing platform(s) 602 may include electronic storage/database 614, one or more processors 616, and/or other components. Computing platform(s) 602 may include communication lines, or ports to enable the exchange of information with a network and/or other computing platforms. Illustration of computing platform(s) 602 in FIG. 23 is not intended to be limiting. Computing platform(s) 602 may include a plurality of hardware, software, and/or firmware components operating together to provide the functionality attributed herein to computing platform(s) 602. For example, computing platform(s) 602 may be implemented by a cloud of computing platforms operating together as computing platform(s) 602.

Processor(s) 616 may be configured to provide information processing capabilities in computing platform(s) 602. As such, processor(s) 616 may include one or more of a digital processor, an analog processor, a digital circuit designed to process information, an analog circuit designed to process information, a state machine, and/or other mechanisms for electronically processing information. Although processor(s) 616 is shown in FIG. 23 as a single entity, this is for illustrative purposes only. In some implementations, processor(s) 616 may include a plurality of processing units. These processing units may be physically located within the same device, or processor(s) 616 may represent processing functionality of a plurality of devices operating in coordination. Processor(s) 616 may be configured to execute modules 608, 610, and/or 612, and/or other modules. Processor(s) 616 may be configured to execute modules 608, 610, and/or 612 and/or other modules by software; hardware; firmware; some combination of software, hardware, and/or firmware; and/or other mechanisms for configuring processing capabilities on processor(s) 616. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 608, 610, and/or 612 are illustrated in FIG. 23 as being implemented within a single processing unit, in implementations in which processor(s) 616 includes multiple processing units, one or more of modules 608, 610, and/or 612 may be implemented remotely from the other modules. The description of the functionality provided by the different modules 608, 610, and/or 612 described below is for illustrative purposes, and is not intended to be limiting, as any of modules 608, 610, and/or 612 may provide more or less functionality than is described. For example, one or more of modules 608, 610, and/or 612 may be eliminated, and some or all of its functionality may be provided by other ones of modules 608, 610, and/or 612. As another example, processor(s) 616 may be configured to execute one or more additional modules that may perform some or all of the functionality attributed below to one of modules 608, 610, and/or 612.

Referring to FIG. 6, an implementation of a first interface 620 is illustrated that is generated using interface generating module 608. As illustrated, the first interface 620 allows the user to identify/select the particular product type (and related information, such as by non-limiting example, product die type, product technology type, product voltage level, device type, or any combination thereof) for which a product system model file is to be generated by the system. As illustrated, the first interface 620 includes several drop down menus 622, 624, 626, 628 which aid the system in determine which product SPICE model(s) for which the user wishes to generate a product system model file. Dropdown menu 622 allows the user to select whether the product is a discrete product or a module product. Dropdown menu 624 allows the user to select what semiconductor process technology is associated with the desired product (in this case a silicon carbide M2 process technology, though any particular type of/naming convention for semiconductor process technology could be employed in various implementations). Dropdown menu 626 allows the user to select what voltage the product is designed to run at, and dropdown menu 628 allows the user to select from a list of specific device(s) that meet the requirements of the first three dropdown menus. Once the particular device type (part number) has been selected and the Submit/Save button in the interface 620 has been pressed, in various system implementations, the system then retrieves the specific product SPICE model from the database 614 and provides it to the SPICE model simulation module 610.

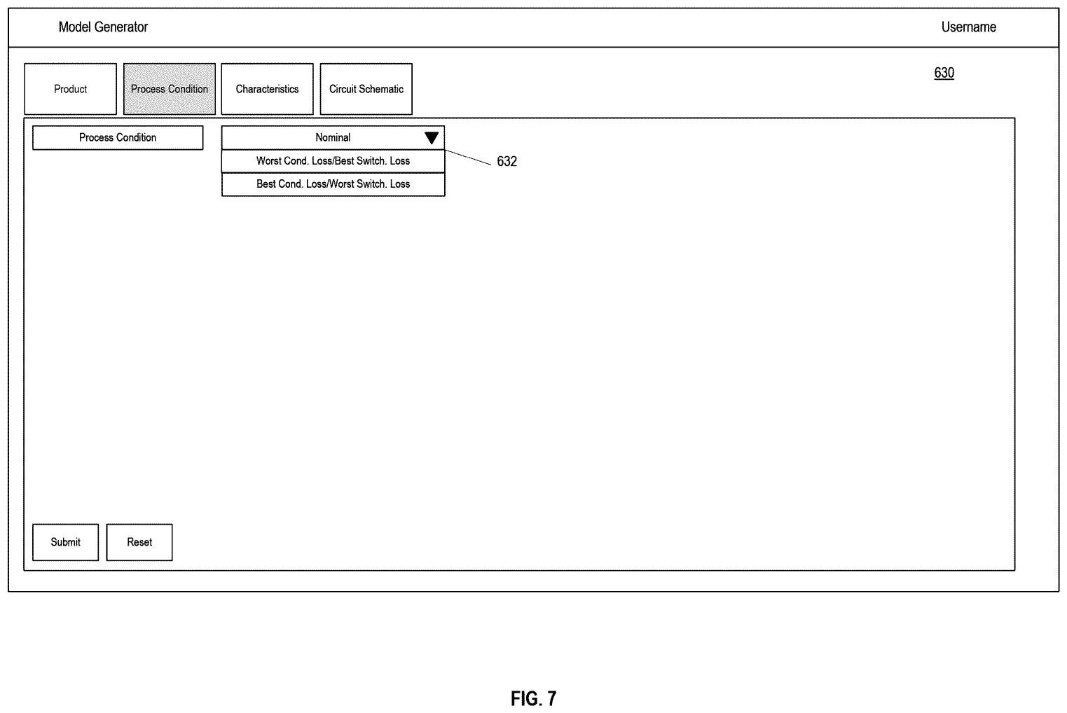

Referring to FIG. 7, an implementation of a second interface 630 is illustrated. This interface 630 permits the user to select the particular process condition(s) to be used by the SPICE simulation module 610 with the product SPICE model when carrying out the simulations. Process condition here refers to the state of the fabrication processing used to make the semiconductor die(s) included in the selected device/product. As illustrated, the interface 630 include a dropdown menu 632 that allows the user to select between three options, a nominal process condition (mean of a particular fab's processing conditions), a worst conduction loss/best switching loss process condition, or a best conduction loss/worst switching loss process condition. The tradeoff between conduction loss and switching loss occurs because in power semiconductor devices, as the capacitance goes up, the RdsON goes down and vice versa. As both of these device characteristics are a direct result of the particular fabrication processing received by a given power semiconductor die, a corner model can be used in various system and method implementations to indicate the effect of the worst and best case processing conditions observed coming out of a given fabrication facility manufacturing a particular semiconductor die. The foregoing is just an example of a particular type of corner model that focuses on the switching and conductions losses; in other implementations, corner models for any other device performance characteristic could also be used and included in the dropdown menu 632 for use in simulation. In various implementations, instead of a corner model, a Monte Carlo model could be used to simulate/indicate the full range of variation of the semiconductor processing for a given semiconductor die to increase the accuracy of simulations across the entire range of possible process conditions. In such an implementation, the product SPICE model selected would also be one generated using a similar Monte Carlo technique using the model generating principles disclosed in the '532 and '533 Patents. In various system implementations, once the Submit/Save button on the interface 630 has been selected, the particular product SPICE model corresponding with the selected process condition (nominal, etc.) is retrieved from the database 614 and provided to the SPICE model simulation module 610.

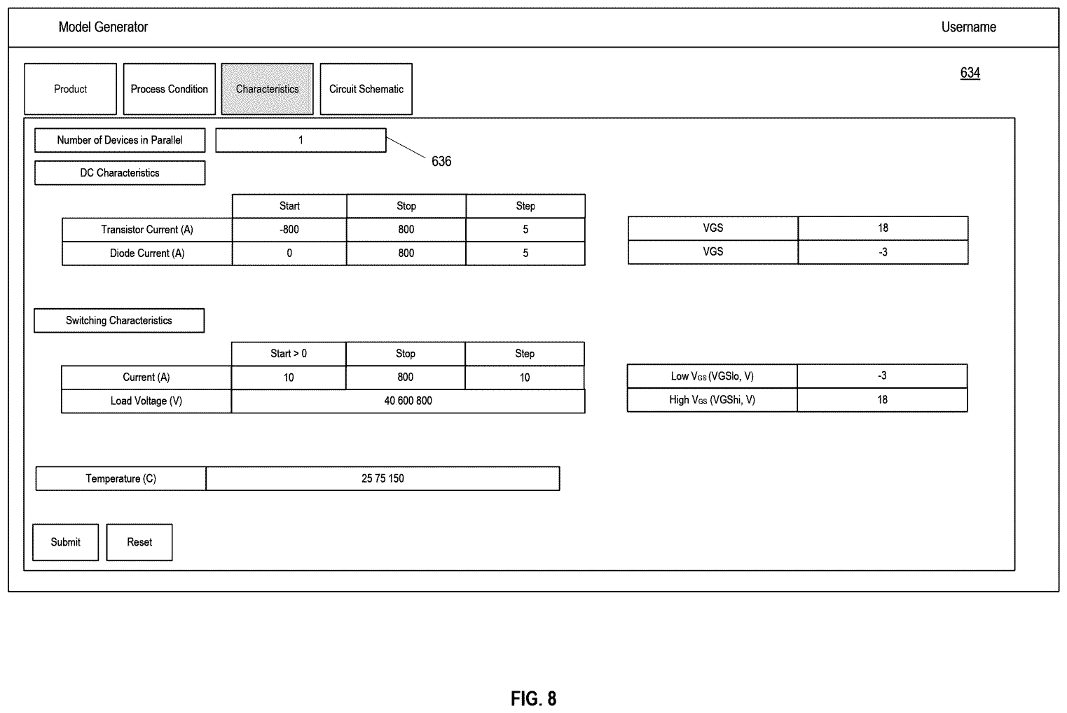

Referring to FIG. 8, an implementation of a third interface 634 is illustrated that is designed to allow the user to enter one or more system characteristics and one or more operating characteristics for which the modeling will be conducted using the product SPICE module by the SPICE model simulation module 610. As illustrated in FIG. 8, the system characteristic of the number of devices in parallel in the particular product/device selected can be entered by the user in textbox 636. The user can then enter a number of operating characteristics for the simulation such as, by non-limiting example, temperature, current, load voltage, voltage source-gate, or any other desired device/product operating parameters. In the implementation illustrated in FIG. 8, the user can enter a number of direct current (DC) characteristics and a number of switching characteristics along with a temperature. As illustrated in FIG. 8, a user-defined range of values can be entered into the text boxes as has illustrated for the Load Voltage under Switching Characteristics and for Temperature. The ability to input a range of values for the simulations at a desired level of granularity can allow the user to create a dense space to allow for accurate interpolation and minimize extrapolation by the system level simulator that utilizes the generated product system model file. In the various system and method implementations, the entered system characteristics and operating characteristics are then supplied to the SPICE model simulation model 610 when the user presses the Submit/Save button in the third interface 634.

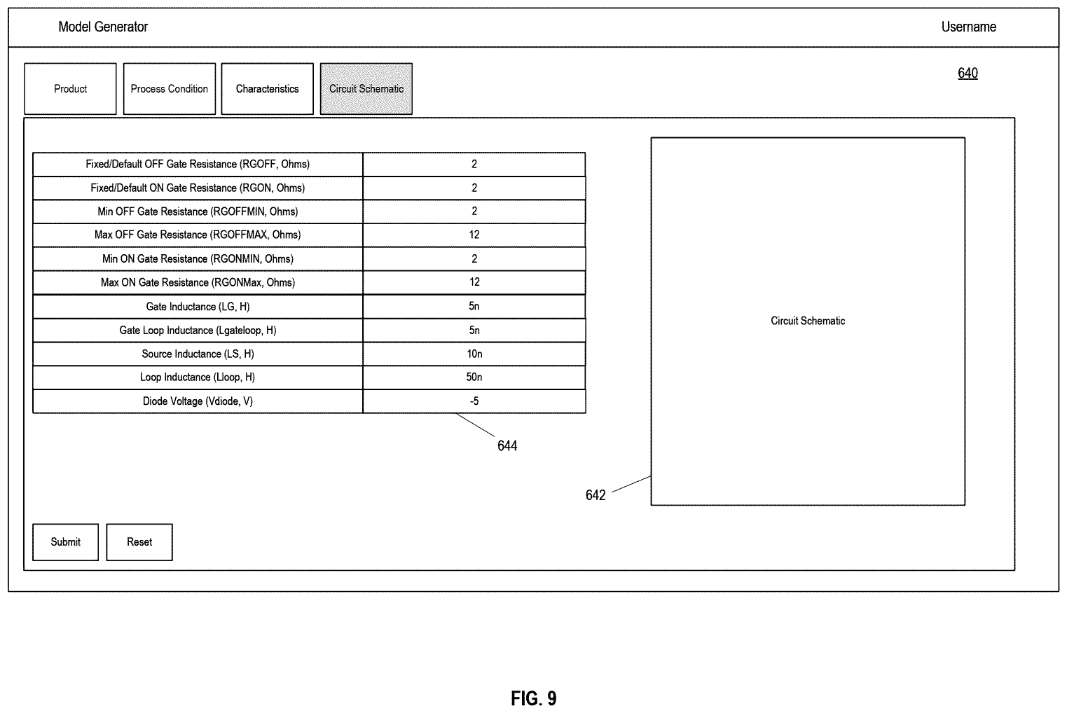

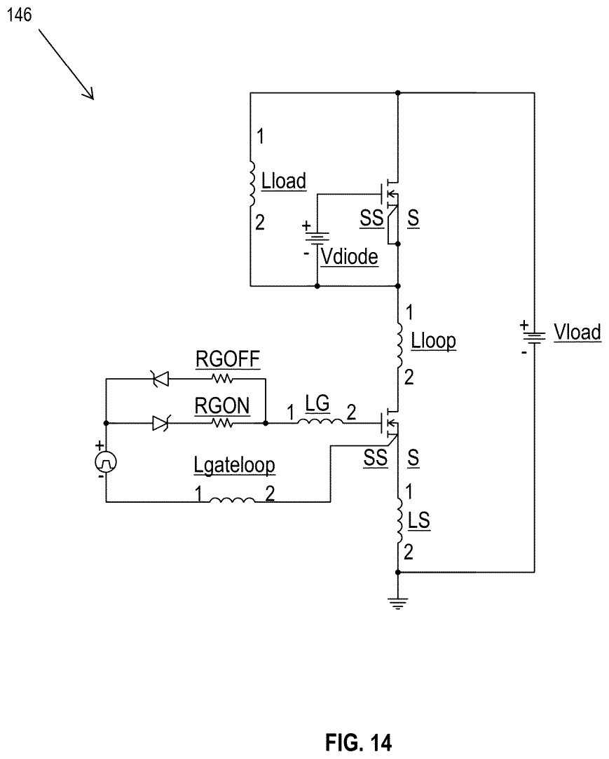

Referring to FIG. 9, an implementation of a fourth interface 640 is illustrated that is used by the user to enter specific circuit characteristics. These circuit characteristics may include various circuit parasitic values and other circuit values that relate to a circuit schematic 642 included on the interface. The circuit schematic 642 is a schematic of the circuit used to create the switching loss data for with the product SPICE model selected by the user. By being able to select circuit parasitics, the user is able to ensure that the switching loss values in the resulting product system model file are as accurate as desired for the designer's end system application. An example circuit schematic 646 that has the components associated with the values in the data table 644 of FIG. 9 is illustrated in FIG. 14. In various implementations, certain parasitics of interest like those illustrated in FIG. 14 and the data table 644 may be included, though in other implementations, other parasitics could be included/replace any of the parasitics illustrated in FIG. 9.

By non-limiting example, the RGON and RGOFF parasitic may have a typical range of between 0 to about 20 Ohms and represents the gate resistance that modulates the speed of the device turn on/off process which affects the switching loss(es). The Gate Inductance (LG) may have a value of between about 1 to about 50 nano Henries and works as a parasitic to affect the Vgs waveform causing an overshoot at plateau voltage during turn on (the inductance acting as a current source) which helps the turn on speed and correspondingly lowers the turn on loss(es). Another parasitic may include the Gate Loop Inductance (Lgateloop) which may have a value between about 1 to 50 nano Henries. The Gate Loop Inductance may not have a large impact on losses during turn off, but it works to increase Tdoff (turn off delay). In some extreme cases, this inductance can cause slow Vgs waveforms and high loss(es). Also, inductances in the gate can cause oscillations with a gate of another device(es) and cause additional corresponding ringing losses. The Source Inductance (LS) may have a value between about 1 to about 20 nano Henries and may cause losses because it lowers Eon because of voltage drop caused by the inductance during positive di/dt and increased Eoff because of voltage overshoot for negative di/dt. This inductance may also slow down the di/dt of the drain current which influence loss(es) in the circuit. Another parasitic that may be included/considered is the Loop Inductance which may have a range of values between about 10 to about 200 nano Henries. Any of a wide variety of other generally present parasitics and/or circuit specific parasitics may be included in the fourth interface 640 to allow the user to enter value(s) and/or ranges of values for use during the simulation process. In the various system and method implementations, when the user presses the Submit button on the fourth interface 640, the values of the various circuit characteristics are provided to the SPICE model simulation module 610. In various system and method implementations, this also represents the point in the method when the SPICE model simulation model 610 uses all of the input provided and the product SPICE model to generate a SPICE model output which is then formatted by the formatting module 612 to a desired file format.

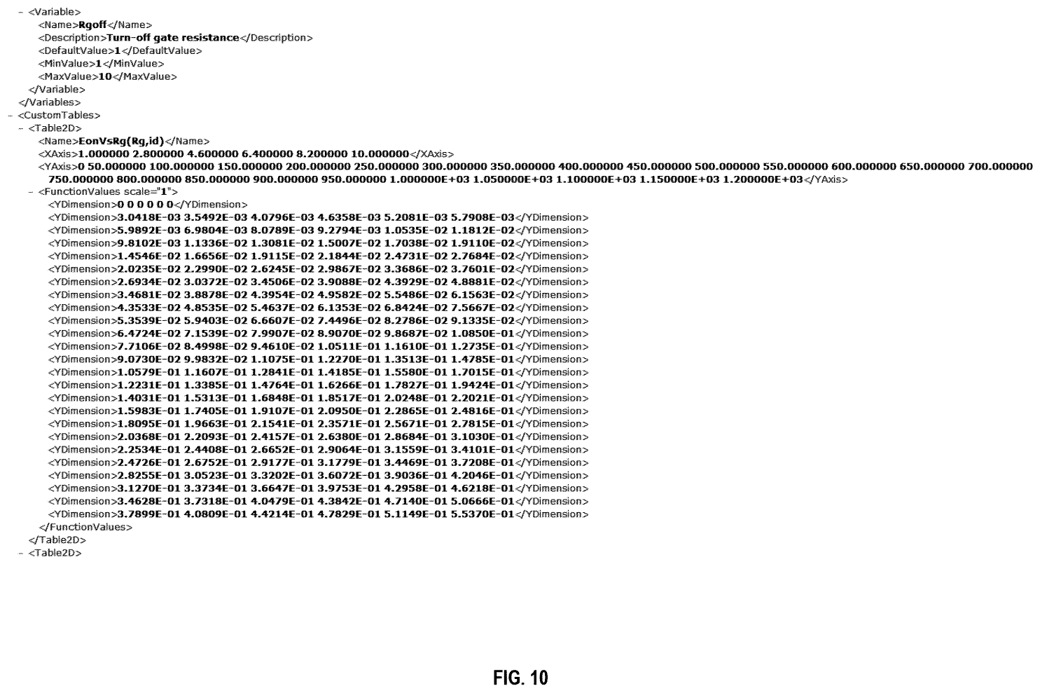

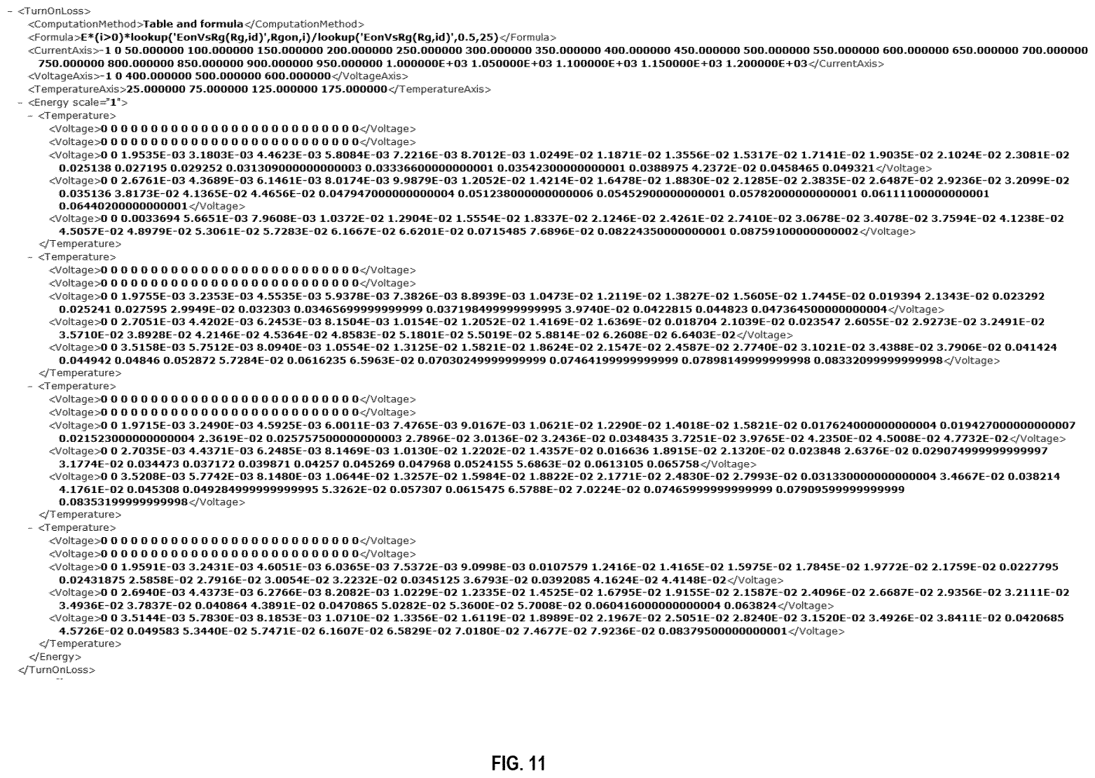

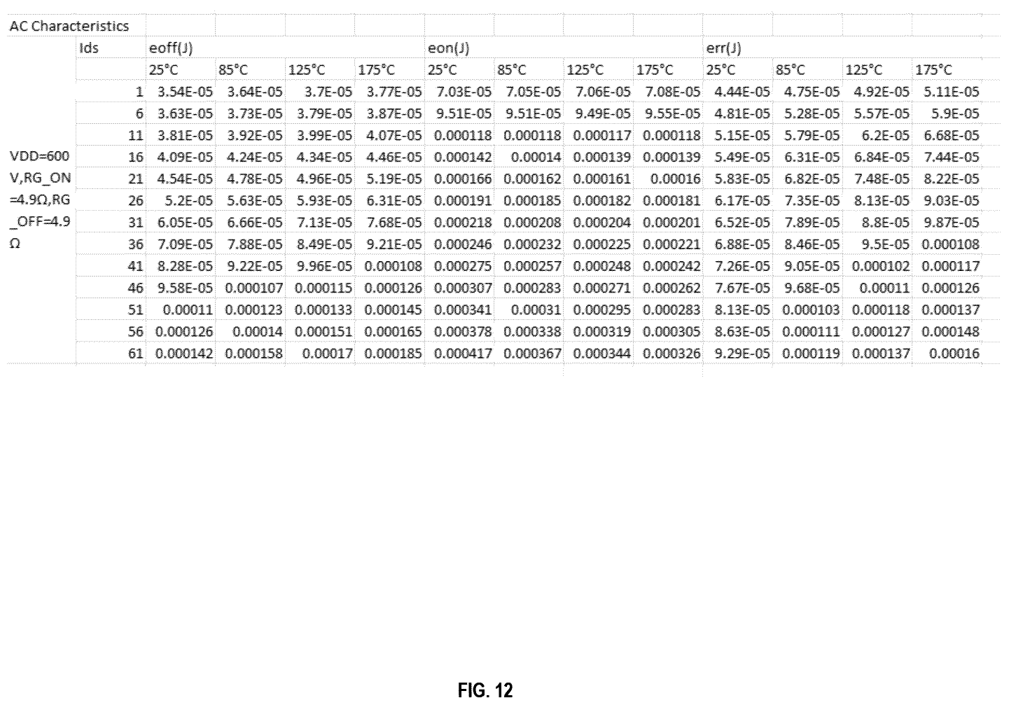

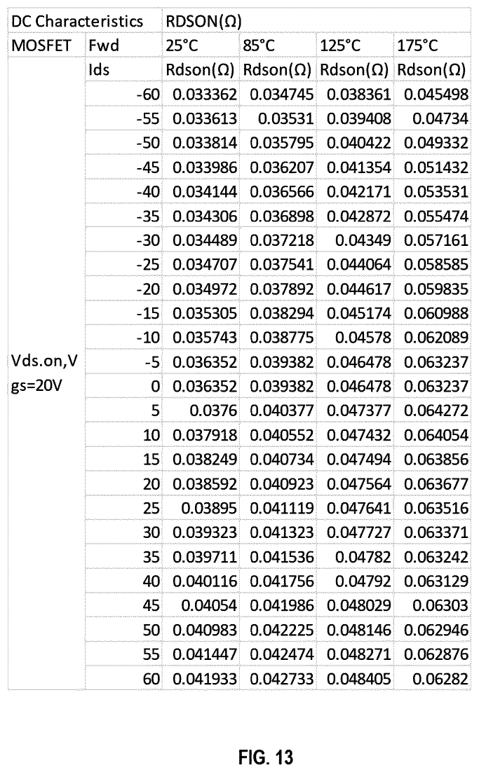

Referring to FIGS. 10 and 11, an illustration of first and second portions of a system model file that includes a structured text file formatted in a PLECS format is illustrated. In this implementation, the format of the structured text file is xml. FIG. 10 shows the associated data for Eon versus Rg across a set of y axis dimensional values which can be plotted into curves to allow the designer to observe the system behavior over the product package's dimensions. FIG. 11 illustrates a set of voltage values for each of a set of different temperature values. This ability to do simulations of voltage response for each of a set of different temperature values can be invaluable to the circuit designer who needs to understand the heat dissipation needs for a given products across the different temperature levels. FIGS. 12 and 13 illustrate output of a plain text file or comma separated text file that is being viewed using the spreadsheet program marketed under the tradename EXCEL® by Microsoft Corporation of Redmond, WA. However, in some implementations, through scripting like that discussed, the formatting module 612 can directly output a file in an xlsx format or any other structured file format desired. FIG. 12 shows temperature dependent Eoff, Eon, and Err at each of four possible operating temperatures and a set of diode voltages (IDs). FIG. 13 illustrates DC characteristics for MOSFET at a set of IDs and set of temperatures showing the effect of temperature on RDson. These modeled data points in the product system model file implementations can then be used by a system level simulator to allow a circuit designer to evaluate whether a certain device will work in a given circuit design and/or how best to integrate it thermally and/or electrically.

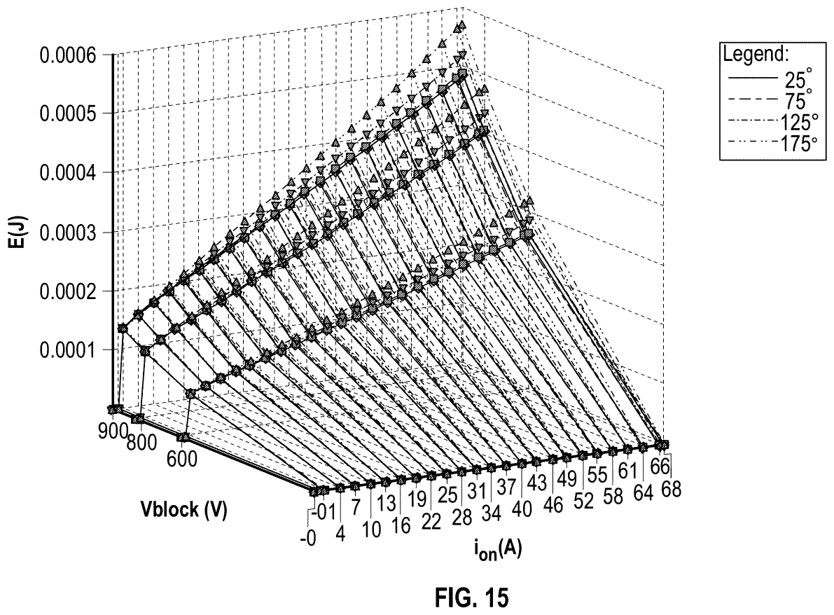

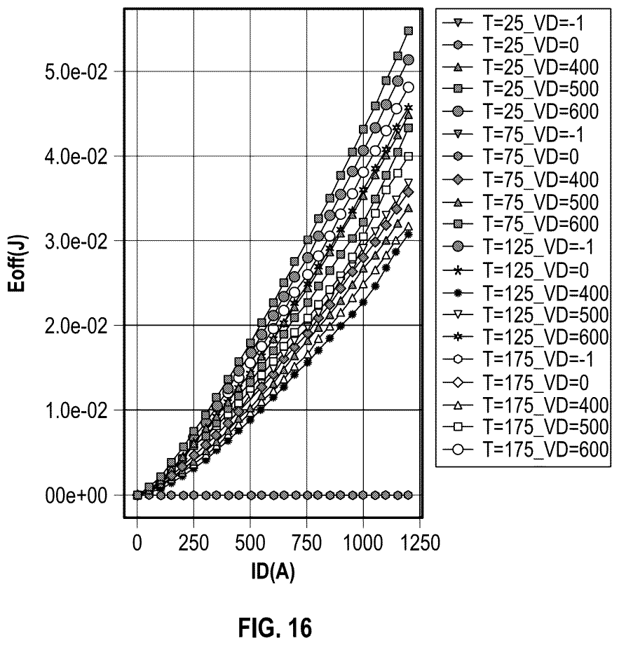

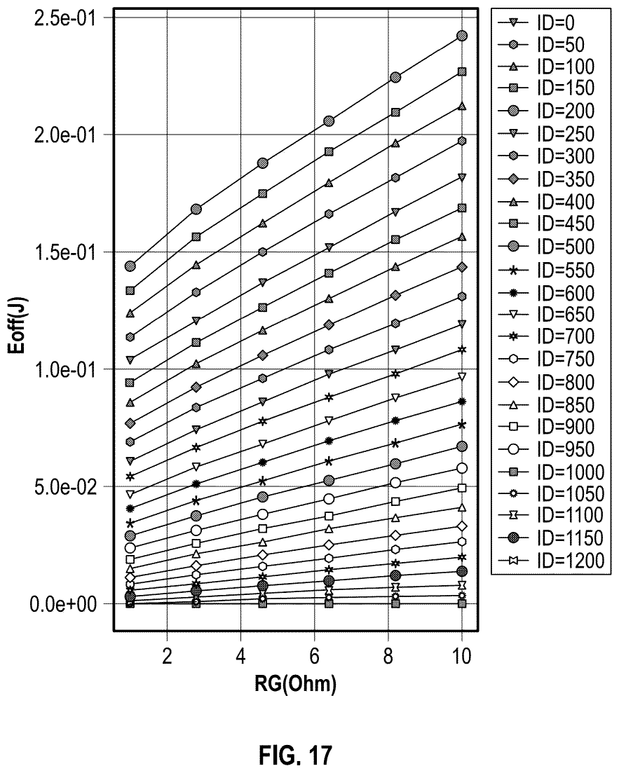

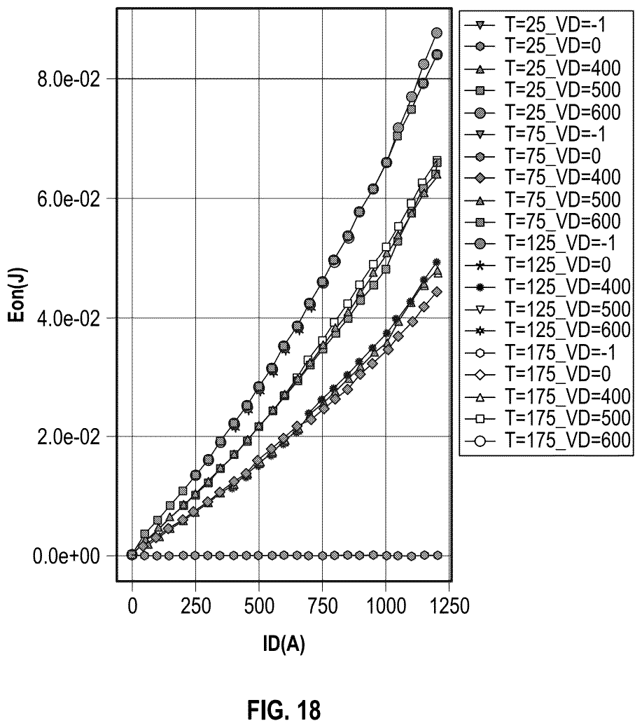

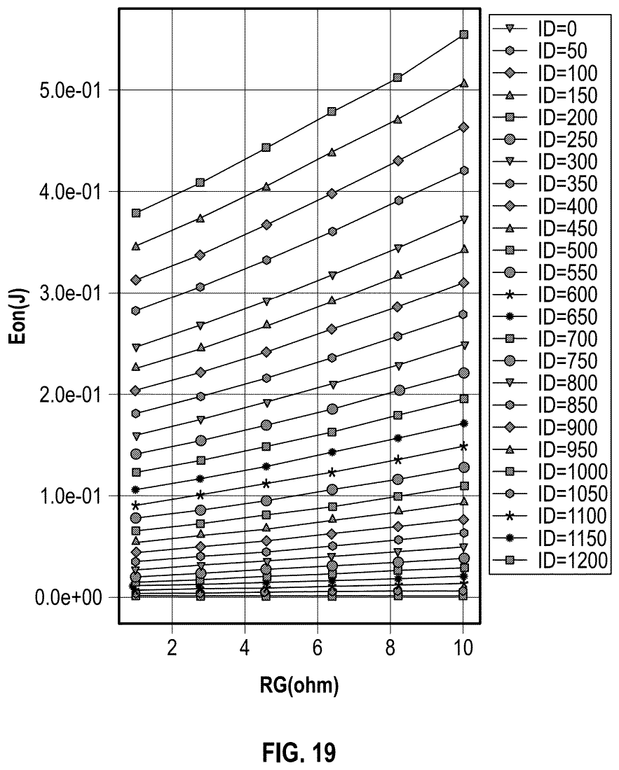

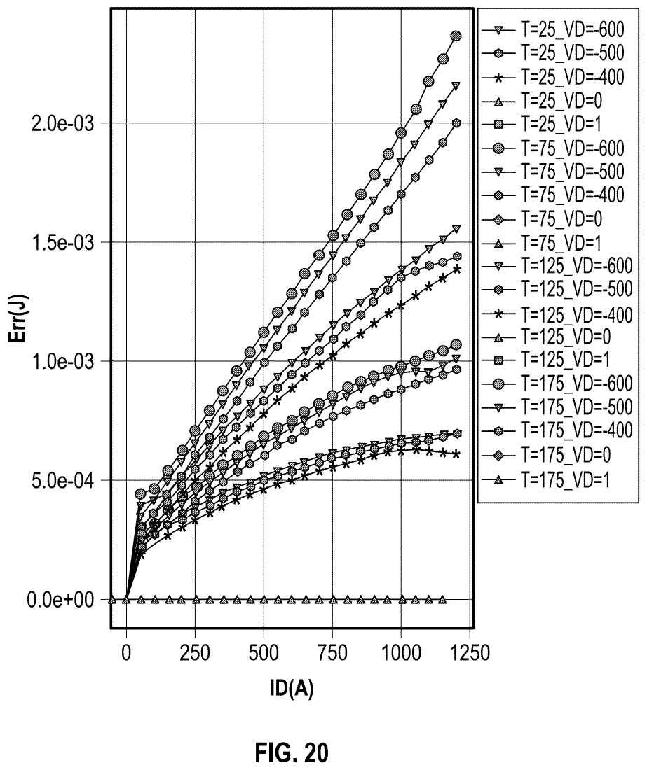

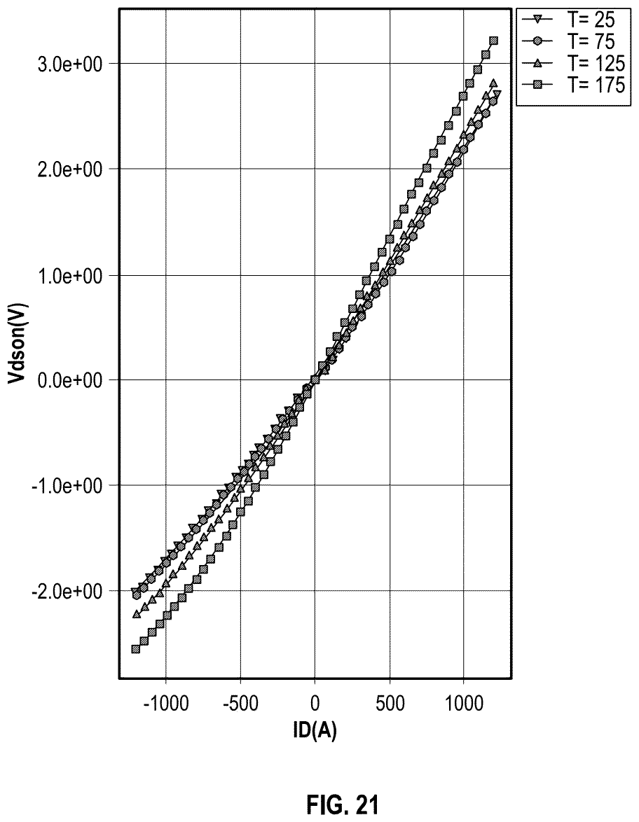

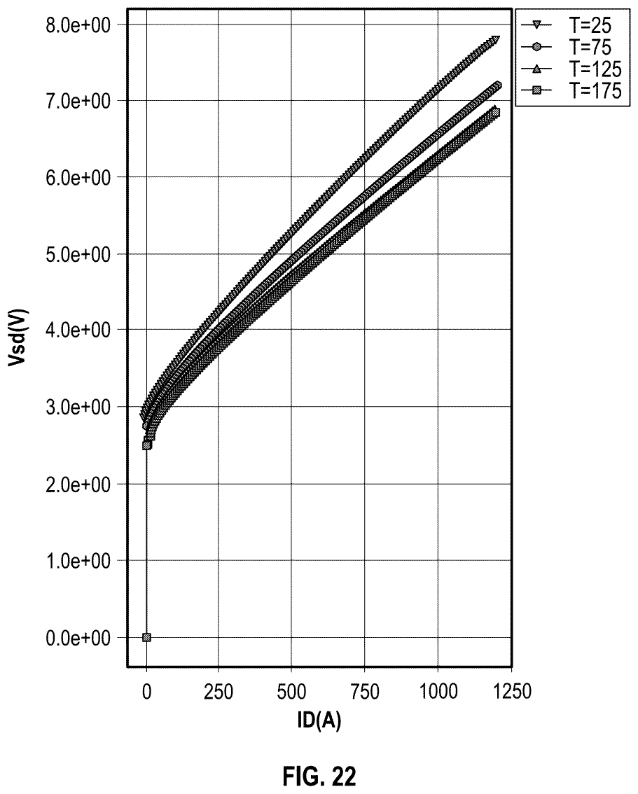

FIG. 15 illustrates an output of a system level simulator that shows a surface where energy E is graphed versus Vblock for various on currents (ion) at four different temperature values. All of the data in this output was derived from a PLECS formatted product system model file and is the result of either plotting of direct data values or interpolation/extrapolation by the system level simulator. FIGS. 16-22 are similar two dimensional outputs from a system level simulator using a PLECS formatted product system model file. FIG. 16 shows a graph of Eoff versus diode current ID for a set of different temperatures at different diode voltages. FIG. 17 is a graph of Eoff versus gate resistance (RG) for a set of diode currents ID. FIG. 18 is a graph of Eon versus diode current (ID) for over a range of temperatures at different diode voltages (VD). FIG. 19 is a graph of Eon versus gate resistance RG for a set of diode current value ID. FIG. 20 is a graph of Err versus diode current ID for a set of temperature values and diode voltages VD. FIG. 21 is a graph of Vdson versus a set of diode currents ID for four different temperatures. FIG. 22 is a graph of Vsd versus diode current ID for four different temperatures as well. These graphs illustrated the significant degree of data granularity available to the system level simulator for these calculations from the product system model file generated using the system and method implementations disclosed herein. This type of data granularity generally not available using laboratory techniques nor available with the same degree of accuracy. Furthermore, the ability to enter and adjust values for parasitics can help the circuit designer understand the product's sensitivity to parasitics. In various products, some parasitic effects get better or worse depending on the type of parasitic. To aid in observing the effects of the parasitics, the modeling can also be carried out to sacrifice some performance parameters. For example, some Eoff can be given up to get better Eon to understand the effects of the parasitics.

The SPICE model simulation module 610 operates using the system characteristics and operating characteristics in various ways to generate each of the desired performance characteristics included in the product system model file. For example, with the defined current values, the module 610 sweeps the current at a given VGS value, measuring the resulting IV to get the conduction loss for a MOSFET diode. In various module implementations, double pulse simulations may be used to get the energy losses using the product SPICE model. In various system implementations, the conduction losses/energies are calculated using IV sweeps with the product SPICE model. Because the SPICE model simulation module 610 can work with the product SPICE model, it can perform the simulations on ideal conditions without interference from the parasitics of a lab set up.

The ability to input circuit parasitics and characteristics to the SPICE model simulation module 610 further allows the establishment of boundary conditions for each simulation where the parasitics are the boundary conditions. However, for IV sweeps used to test switching characteristics, the parasitics input may not be used. Because the product SPICE model implementations used with the SPICE model simulation module 610 may also include a thermal model, the SPICE model simulation module 610 can include a thermal impedance network such as a Cauer or Foster network in the product system model file. This may be done in various implementations by the SPICE model simulation module 610 extracting the thermal model and adding it to the product system model file. In various system and method implementations, however, additional thermal characteristics can be added to allow the modeling to be conducted with corner thermal models and a Cauer network or Foster network that is used by the module to perform additional thermal modeling for inclusion in the product system model file. These corner thermal models could include a typical operating case or a worst case (high temperature, low temperature, or both). In such implementations, in addition to the circuit schematic, different representations of particular thermal networks that can be used may be selectable by the user. The product system model file generated by the SPICE model simulation module 610 is a part-level model valid for use in system-level simulations but is not actually itself a SPICE model but rather a table model that contains the performance data needed for the system level simulator to use it for its simulation work.

In various system implementations, the SPICE model output of the SPICE model simulation module 610 needs additional formatting to be organized into the format desired for the product system model file. Various implementations of formatting modules 612 may utilize scripts and other programs to automatically perform the data rearrangement. In various implementations, the scripts may be Python language scripts. Following the desired formatting and formation of the product system model file by the formatting module 612, the resulting product system model file may be made available for immediate downloading to the user via the user interfaces and/or may be saved into the database 614 for later downloading/access by the user or another user who wishes to use the file. In various implementations, the product system model file may be made available by a semiconductor device manufacturer along with the datasheet for each particular product being manufactured.

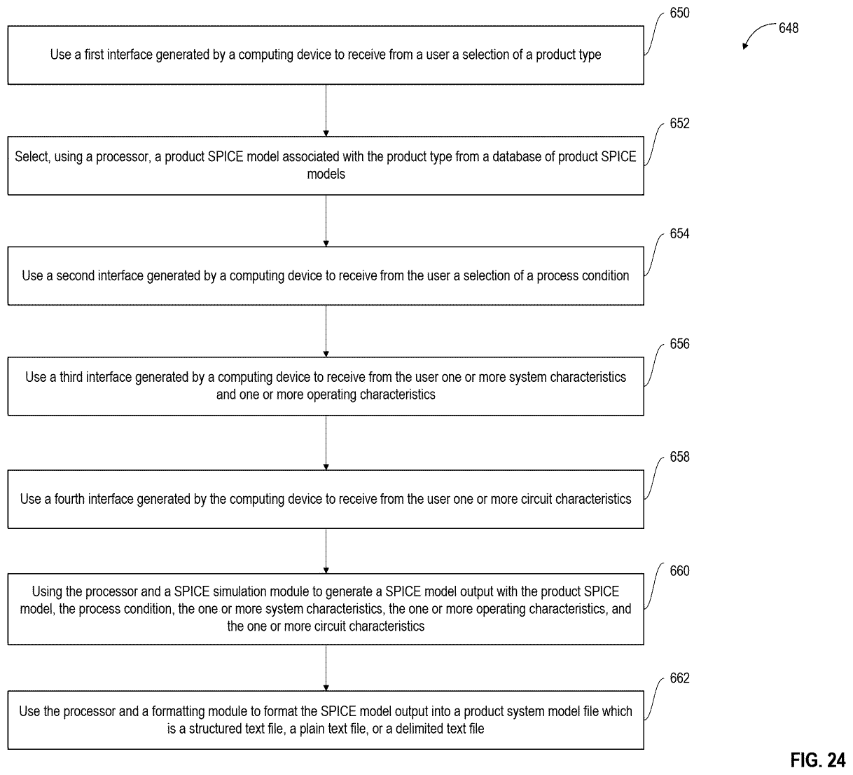

The various system implementations disclosed herein may utilize various implementations of a method of generating a product system model for use in system level simulations. Referring to FIG. 24, a flow diagram of a method implementation is illustrated. As illustrated, the method 648 may include using a first interface generated by a computing device to receive from a user a selection of a product type (step 650) and selecting, using a processor, a product SPICE model associated with the product type from a database of product SPICE models (step 652). The database may be any database disclosed herein and the computing device may be any computing device implementation disclosed herein. The method also includes using a second interface generated by the computing device to receive from the user a selection of a process condition (step 654) and using a third interface generated by the computing device to receive from the user one or more system characteristics and one or more operating characteristics (step 656). The process condition, one or more system characteristics, and one or more operating characteristics may be any disclosed in this document. The method also includes using a fourth interface generated by the computing device to receive from the user one or more circuit characteristics, which may be any of the circuit characteristics including parasitics disclosed herein (step 658). The method also includes using the processor and a SPICE simulation module to generate a SPICE model output with the product SPICE module, the process condition, the one or more systems characteristics, the one or more operating characteristics, and the one or more circuit characteristics (step 660). The SPICE simulation module may be any disclosed in this document and the method of simulation carried out may be any disclosed herein. The method also includes using the processor and a formatting module to format the SPICE model output into a product system model file which may be a structured text file, a plain text file, or a delimited text file like any disclosed herein (step 662). A wide variety of method implementations may be constructed using the principles disclosed herein.

The various semiconductor devices for which the disclosed system and method implementations may be employed may be any of a wide variety of device types, including, by non-limiting example, metal oxide semiconductor field effect transistors (MOSFETs), insulated gate bipolar transistors (IGBITs), diodes, power semiconductor devices, silicon controlled rectifiers, transistors, or any other semiconductor device type. Also, the various product types may include a single die, two die, or multiple die included in a module. Those of ordinary skill will readily appreciate how to adapt the principles disclosed herein to various semiconductor die or device types.

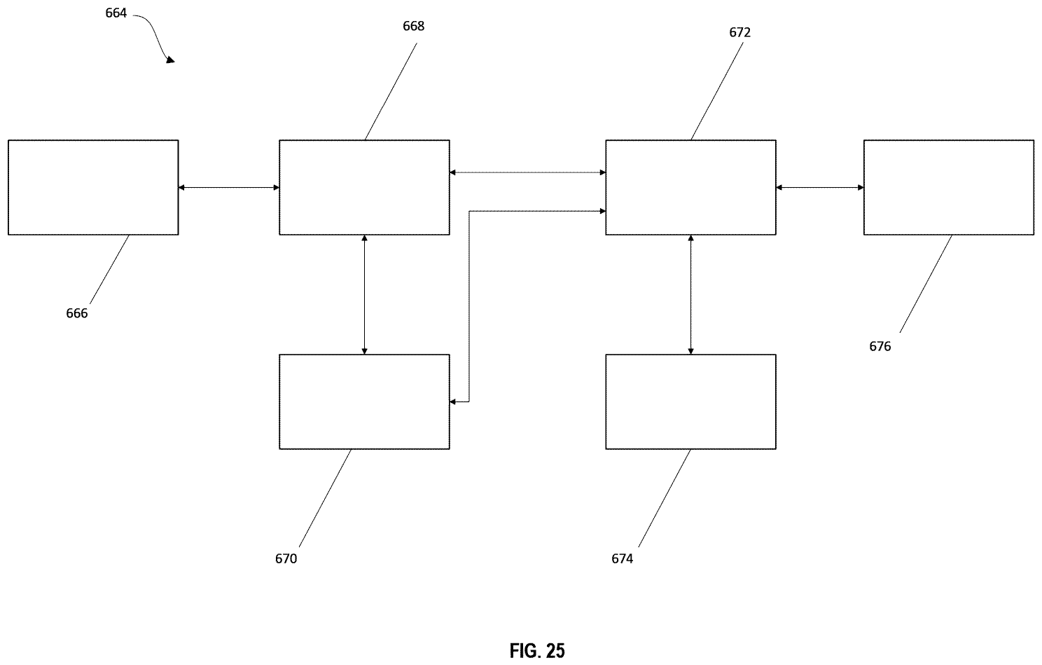

Referring to FIG. 25, a flow diagram of a system for designing a semiconductor product 664 is illustrated. As illustrated, the user utilizes portal module 666 to obtain secured access to the system. In various system implementations, the user may utilize a computing device/remote platform(s) 604 and/or engage with various external resources 618 like those illustrated in FIG. 23 in the secure access process. In some implementations, the portal module 666 generates a website or application interface that requests a username and password for the user and, if the user has not created an account, allows the user to create an account with a username and password. In other implementations, the portal module 666 utilizes a security key, a passkey, a passcode, a facial recognition profile, a fingerprint recognition profile, a text, email, or authentication application, two factor authentication, or another hardware or biometric identification system and/or method to allow the user to authenticate with the system along with corresponding computing interface(s). When the user has authenticated to the system via the portal module 666, a discrete semiconductor device module 668 then generates one or more computer interfaces designed to allow the user to select one or more discrete device die and a selection of at least one test condition. The discrete semiconductor device module 668 then sends the selected discrete device die information to die system modeling module 670 which then utilizes a predictive model to generate at least a graphic design file, a product die configuration, a package bonding diagram, a product SPICE model, one or more datasheet characteristics, and/or a product datasheet.

The die system modeling module 670 then sends the die information generated to a module system module 672 which generates one or more computing interfaces that allow the user to select a module type and then generates a module configuration file and a module bonding diagram. The module system module 672 then send the module type, module configuration file, and module bonding diagram to a three dimensional simulation module 674 that then generates a three dimensional model for the semiconductor product module and then either itself or in combination with the module system module 672 sends the module bonding diagram, a product SPICE model that contains module packaging, and the three dimensional model to a SPICE model simulation module 676. The SPICE model simulation module 676 then generates one or more computer interfaces that receive from the user a selection of a process condition, one or more system characteristics, one or more operating characteristics, and/or one or more circuit characteristics. The SPICE model simulation module 676 then generates a SPICE model output that includes module packaging, the process condition(s), the one or more system characteristics, the one or more operating characteristics, and/or the one or more circuit characteristics and then formats these outputs into a product system model file. The SPICE model simulation module 676 then generates a computing interface(s) that allows the user to obtain access to the product system module file in the form of a structured text file, a plain text file and/or a delimited text file. In some implementations, the product system module file is configured for use in a Piecewise Linear Electrical Circuit Simulation (PLECS) system like those disclosed herein.

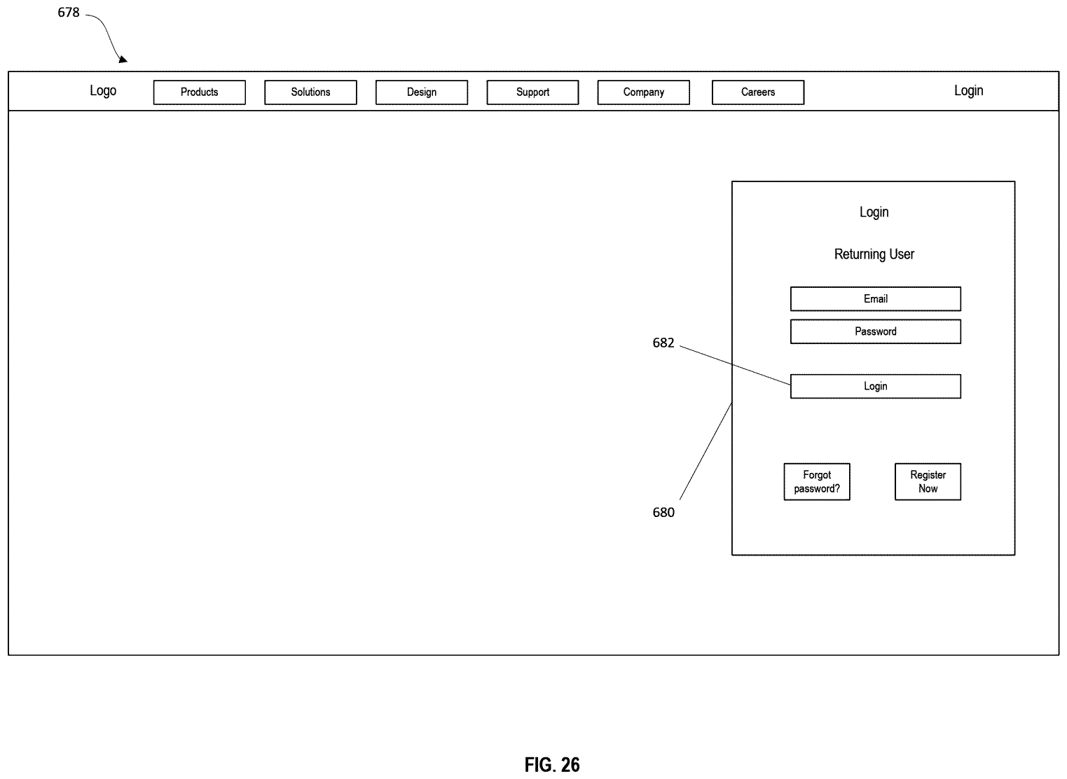

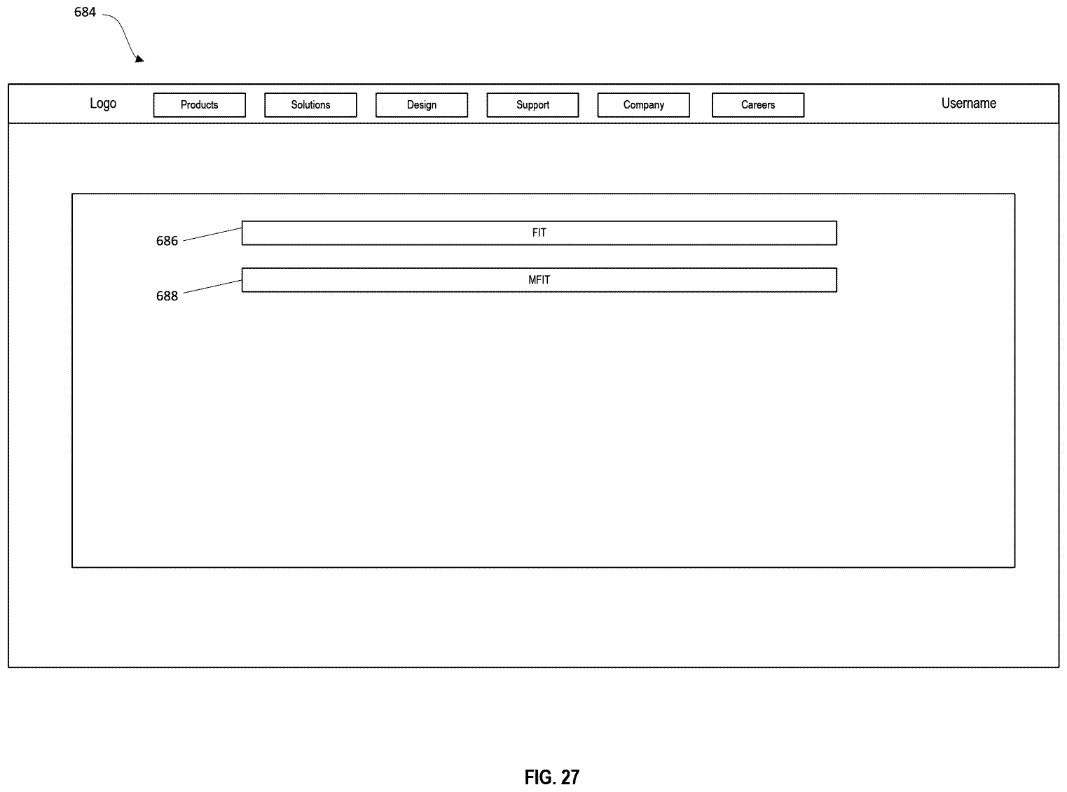

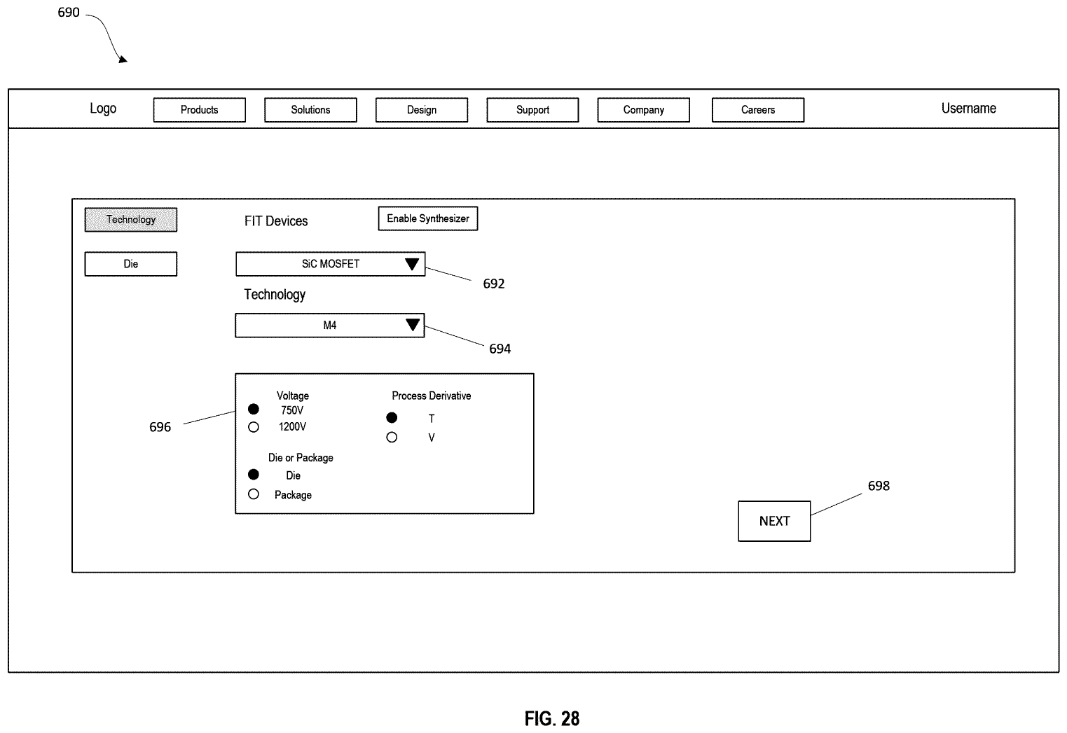

Referring to FIG. 26, an implementation of an application interface (login interface) 678 generated by the portal module 666 is illustrated. This login interface 678 may be created in response to the user selecting the “Login” option at the top right of the interface which then brings up window 680 which allows the user to enter an email address and password in this implementation where an email address serves as a username and then press the login button 682 to be authenticated using the portal module 666. As illustrated, additional buttons/controls on the window 680 allow a user to set up an account (“Register Now”) or reset a password (“Forgot Password?”). While the use of an email address and password for authentication in the window 680 are illustrated in the interface of FIG. 26, any of the previously mentioned authentication methods and their associated interface designs may be utilized in various system implementations (passkey, passphrase, fingerprint, facial recognition, etc.). Following validation of the user's credentials by the portal module 666, the portal module 666 then generates a simulation selection interface 684 illustrated in FIG. 27. In this interface, the user can select whether to begin die-level simulations by selecting the FIT button 686 or to do module-level simulations by selecting the MFIT button 688. When the user selects the FIT button 686, the user then activates the die system modeling module 670 which, in response, generates product design interface 690, an implementation of which is illustrated in FIG. 28.

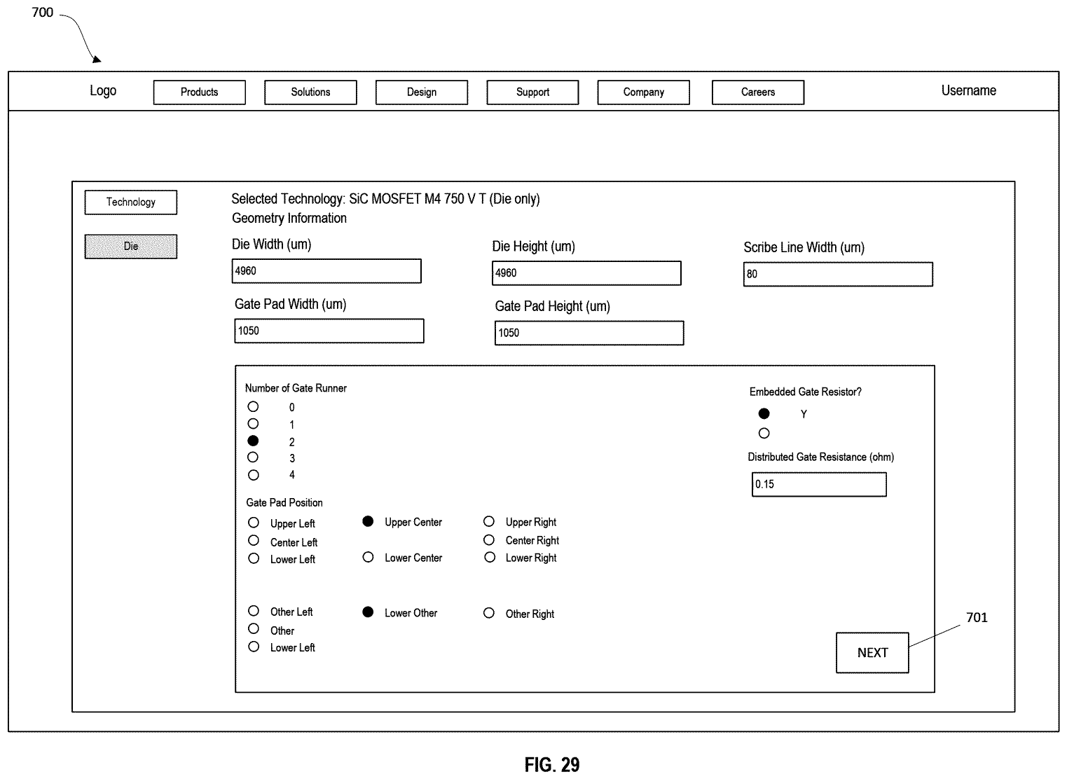

In the product design interface 690, the user can select at least one discrete device product design using drop down menu 692 and a corresponding product technology using drop down menu 694. Here the discrete device product design selected is a silicon carbide metal oxide field effect transistor (SiC MOSFET) and the technology (semiconductor process technology) is M4. The product design interface 690 also includes a test interface 696 which allows for selecting of at least one test/operating condition. Here the voltage has been set to 750 V, the simulation will be done at the die level, and the T process derivative has been selected in the test interface 696. At this point, the user selects the “NEXT” button 698 which posts the selected product and test information to the die system modeling module 670 which in response generates die configuration interface 700, an implementation of which is illustrated in FIG. 29. The die configuration interface 700 allows the user to enter the specific data relating to the die size, scribe line width, gate pad or other pad dimensions, gate runners, gate pad locations, whether an embedded gate resister is included, and gate resistance parameters. All of these are for the exemplary purposes of this disclosure, as many other die-level physical configuration and electrical parameters could be entered using this interface in various other system implementations.

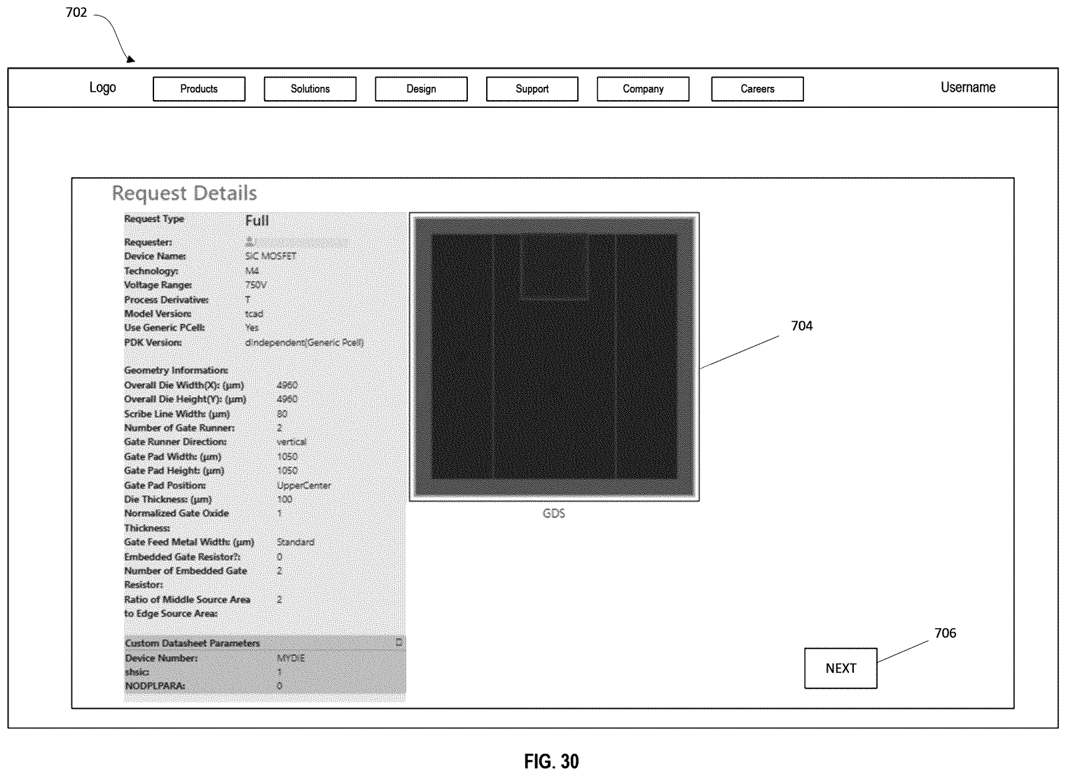

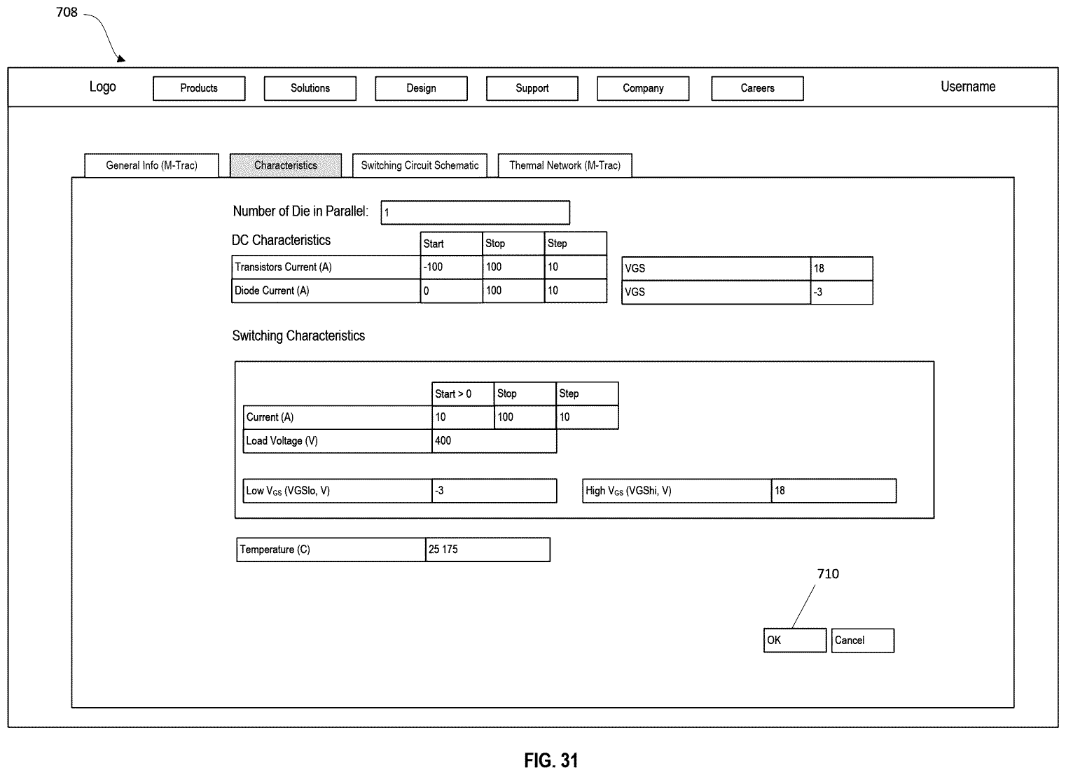

In various system implementations, with the information entered/selected by the user in the die configuration interface 700, the user presses the “Next Button” 701 and, in response, the die system modeling module generates a die summary interface 702 like that illustrated in FIG. 30. In this implementation, the die summary interface 702 includes a die schematic 704 which in this implementation illustrates the pad configuration of the SiC MOSFET. At this point, the user can check the summary information displayed and determine if the results are as expected/anticipated before moving to additional data entry activities. If the summary data is as expected, the user selects the “Next” button 706 and in response the die system modeling module 670 generates a characteristics interface 708, an implementation of which is illustrated in FIG. 31.

The user then uses the characteristics interface 708 to set up various parameters associated with the package to which the semiconductor die previously selected will be bonded. In the characteristics interface 708, the user can select various parameters including, by non-limiting example, the number of parallel die in the package, the direct current characteristics, the switching characteristics, and the temperature. The foregoing parameters reflect the selection of a MOSFET used in a switching circuit, so in other implementations, other device-specific characteristics may be listed in the characteristics interface 708. Following the entry of the requested package-level data in the characteristics interface, the user selects the “OK” button 710 and in response the die system modeling module 670 generates a circuit design interface 712.

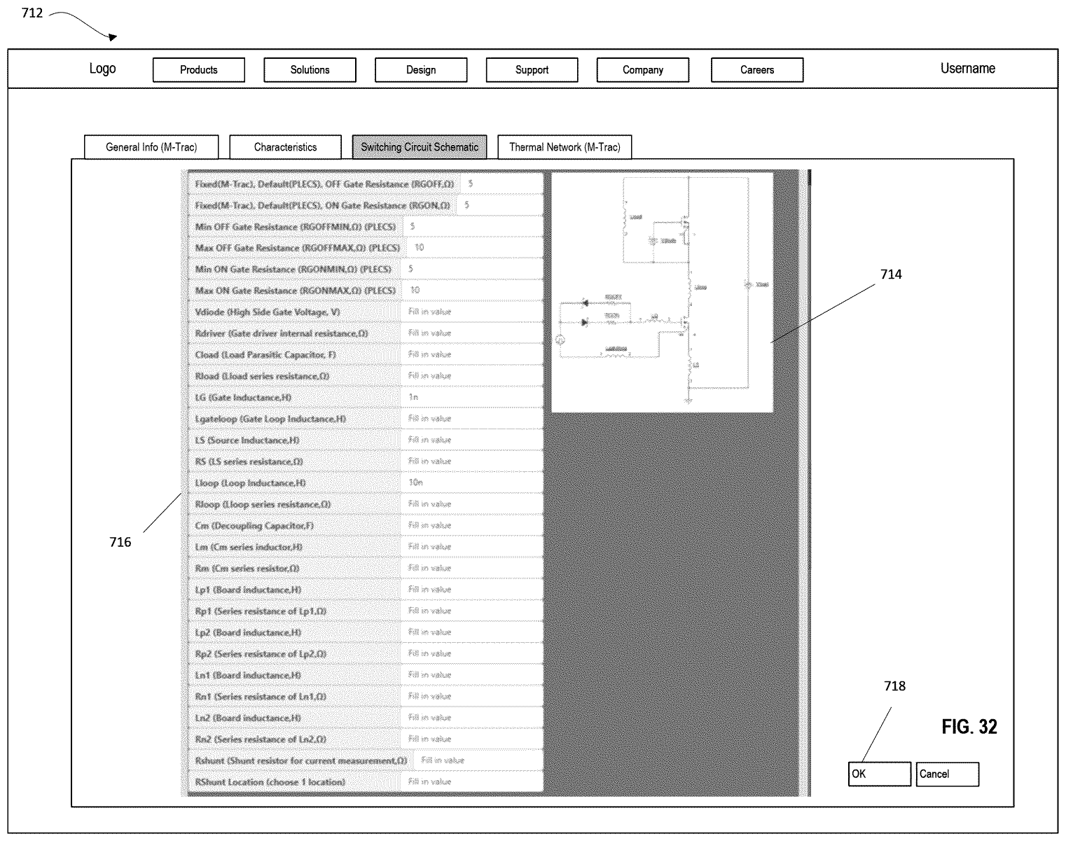

The circuit design interface 712 may, in various implementations, allow the user enter parameters for circuit components of a particular circuit design already associated with the semiconductor die previously selected. In some system implementations, the user may select from a set of circuit designs in which the previously selected semiconductor die can be used. In yet other system implementations, the user may be able to select various circuit components and build/design a desired circuit that includes one or more of the previously selected semiconductor die. In the circuit design interface 712 illustrated in FIG. 32, a switching circuit schematic 714 is illustrated and an associated table 716 that contains the various circuit parameters and circuit component parameters is included for the user to make value selections/entries or review default entered values based on the circuit schematic 714. When the user has completed review/editing/design of the circuit schematic 714 and/or updated/reviewed/entered the values for the various required parameters in the associated table 716, the user selects the “OK” button 718 and the various parameters in the circuit design interface 712 and in the previous interfaces are provided to the die system modeling module 670 for modeling.

The die system modeling module 670 then performs various die-level modeling steps as previously disclosed herein in the various die modeling system and method implementations with various modules included therein previously disclosed herein such as a predictive modeling module, a graphic design system module, a build diagram system module, a product SPICE generating module, a product simulation module, and/or a data formation module. In various system and method implementations, the die system modeling module 670 may generate, using any, all, or any combination of the previous modules, a product die configuration, a graphic design system file, a package bonding diagram, a product SPICE model, and/or a product datasheet. In other implementations the die bonding diagram, datasheet characteristics, or other desired die-level and/or die-package level information may be included in the summary interface 702.

In various system and method implementations, the system may also receive a selection of a package type where the package type is included in the product die configuration. The system may also include selecting a die SPICE model corresponding with the at least one discrete device die previously selected and selecting a package SPICE model corresponding with the selected package type. In various system and method implementations, the die SPICE model and the package SPICE model are used to generate the product SPICE model. In various system and method implementations, a virtual clip like any disclosed herein may be utilized in building a package bonding diagram during the design of the discrete device product.

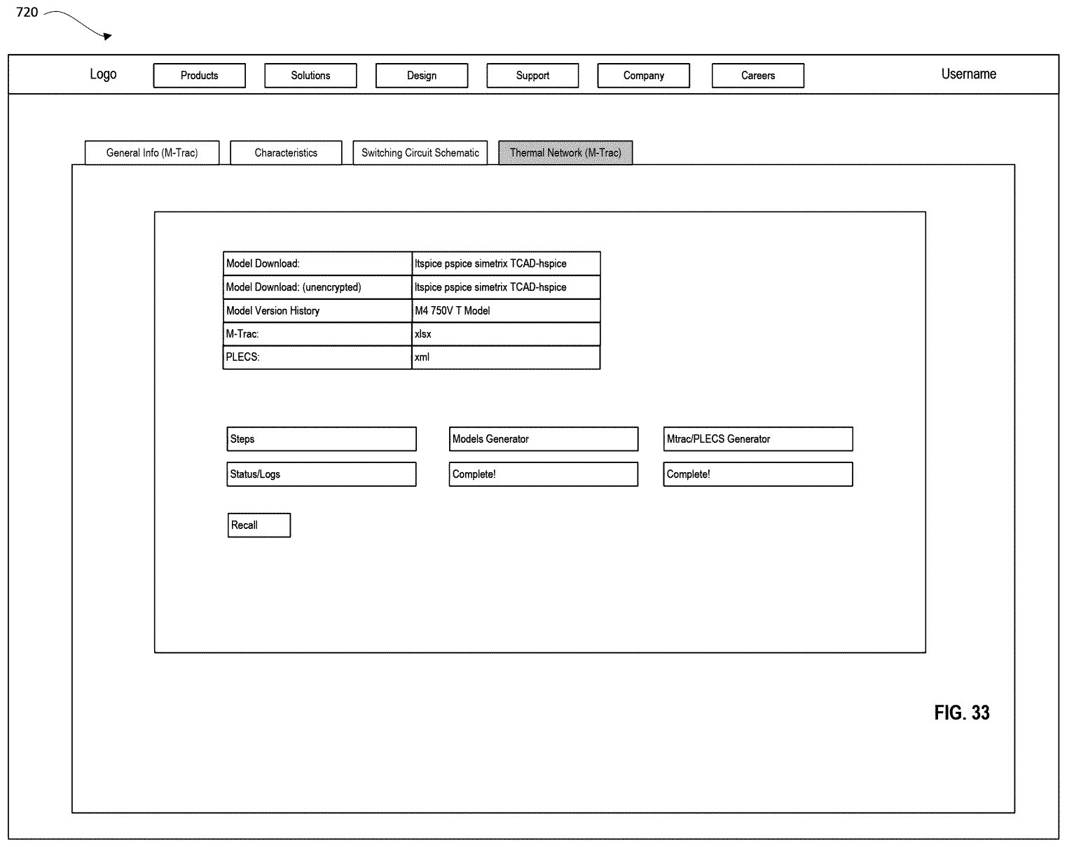

Following the completion of the die-level modeling the die system modeling module 670 then generates model output interface 720 an implementation of which is illustrated in FIG. 33. In various system implementations, the model output interface 720 may include links or other icons that the user can use to download any of the die level modeling results (bonding diagram, datasheet, etc.) similar to the other interface designs disclosed herein. In other system implementations, the model output interface 720 may not include the ability to download the results, but the outputs may be downloadable following completion of further module-level simulations. In some implementations, the user may be done with use of the system at the die-level, but where the user wishes to construct a model of the module/module package in which the now-modeled die will operate and corresponding data for use in a system level simulator, the user will move to module modeling.

Following the completion of the die system modeling, the die system modeling module 670 then, in various system implementations, routes the user back to the portal module 666 which then generates the simulation selection interface 684 illustrated in FIG. 27 to allow the user to select the MFIT button 688 which then sends over the results of the die system modeling module 670 and discrete semiconductor device module 668 to the module system module 672.

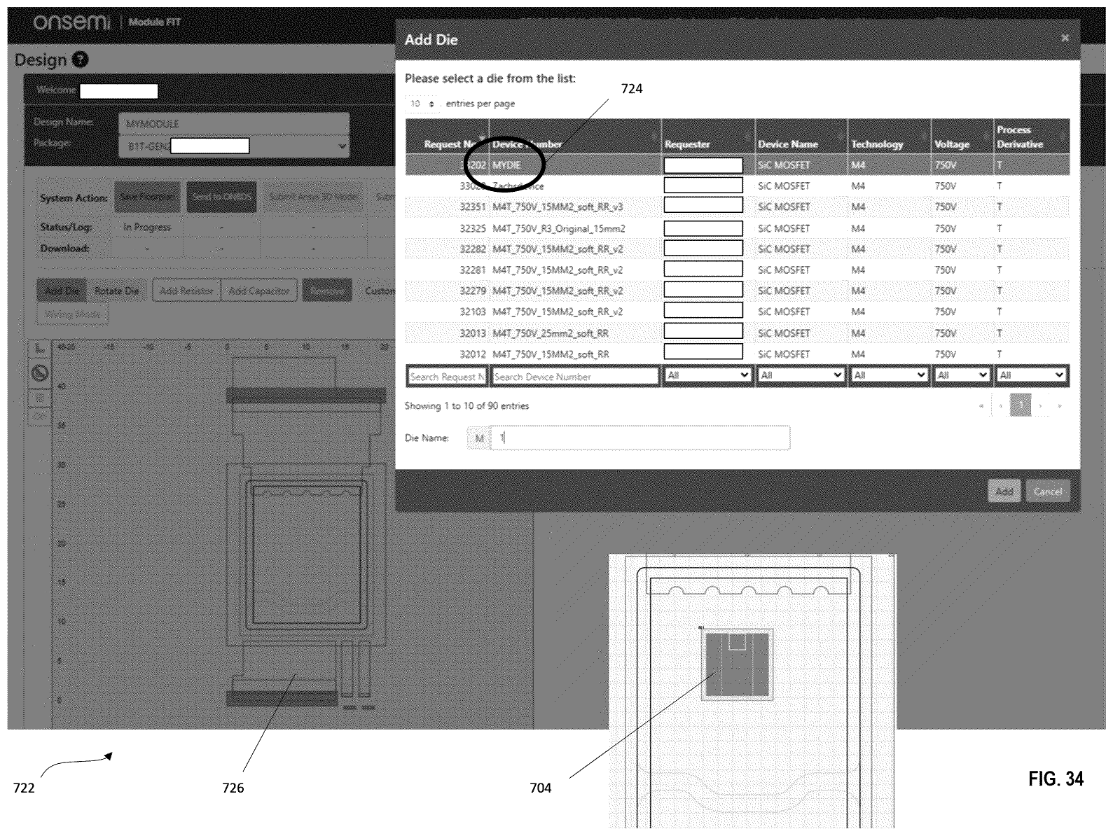

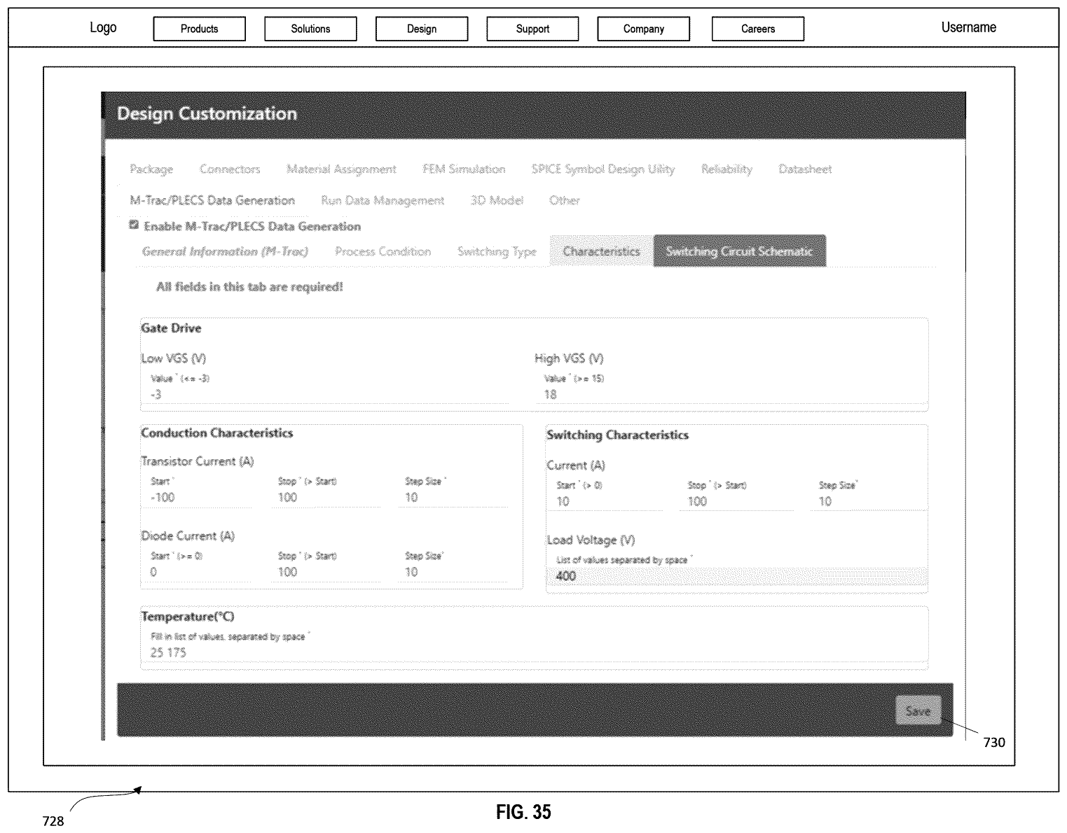

The module system module 672 then generates a module characteristics interface 722, an implementation of which is illustrated in FIG. 34. The user employs various components of the module characteristics interface 722 to begin setting up the module-level modeling process. The user begins by selecting a particular module design from a list of predefined designs or by designing various aspects of the module using the module characteristics interface 722 to form a module schematic 726 illustrated in FIG. 34. With the module schematic, the user then selects the die previously modeled from a list of modeled die, which in this case (as indicated in the table in the summary interface 702 in FIG. 30) is labeled as “MYDIE” 724. Following the selection of the die, FIG. 34 illustrates an additional view of the module schematic 726 that shows how the die schematic 704 illustrated in FIG. 30 now appears in the module schematic 726 and is ready for the user to use in setting the position of the die relative to the module components. Following the setting of the position of the die, the user can use the module schematic 726 to set the position of various interconnects and other die or other passive components consistent with the methods and systems disclosed in the '533 Patent previously incorporated herein by reference to form a finished module design. At this point the module system module 672 generates a module configuration file and a module bonding diagram and sends these with a product SPICE model for the module to a three dimensional simulation module 674 operatively coupled with the module system module 672. In various system implementations, in response to sending these items to the three dimensional simulation module 674, the module system module 672 generates characteristics interface 728, an implementations of which is illustrated in FIG. 35.

In various system implementations, the product SPICE model employed may include at least one die SPICE model, a module packaging parasitic extraction model, and a thermal model that includes module packaging. These models may be like any similar models disclosed in this document.

In the particular characteristics interface 728 illustrated in FIG. 35, the user can ensure that these items are transmitted to the three dimensional simulation module during design time by selecting the “Enable M-Trac/PLECS Data Generation” check box in the characteristics interface 728. While the use of a check box to enable transmission is illustrated in the interface of FIG. 35, in other implementations the transmission may occur automatically or in response to pressing a button or other control during the design activity.

Referring to FIG. 35, the characteristics interface 728 allows the user to enter various operational/configuration parameters for the devices and/or circuit components and/or circuit operational conditions that the three dimensional simulation module 674 and SPICE model simulation module 676 will use during their modeling and simulation work. In some implementations, instead of the module system module 672 generating the characteristics interface 728, the SPICE model simulations module 676 may be used to generate and collect the information instead, sending the relevant portions to the three dimensional simulation module 674.

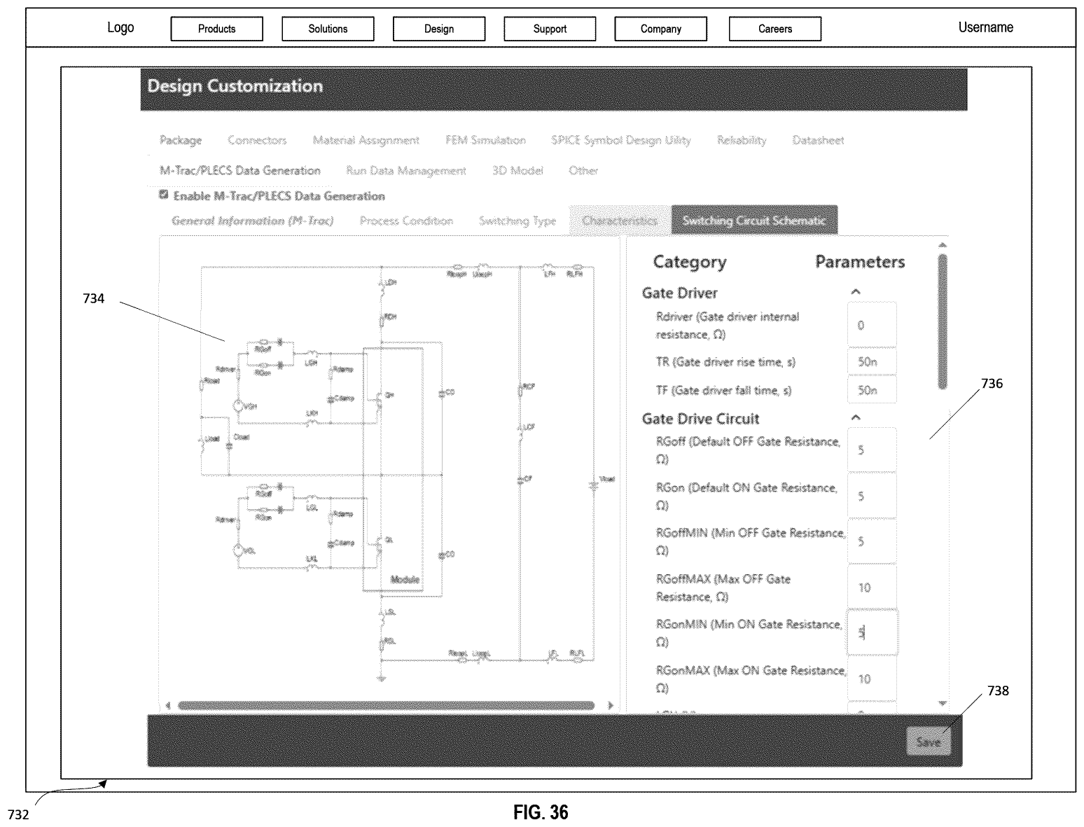

After the operational/configuration parameters are entered in the characteristics interface 728, the user selects the button “Save” 730 and in response the module system module 672, the three dimensional simulation module 674, and/or the SPICE model simulation module 676 receive/store the parameters. Also, in various system implementations, either the three dimensional simulation module 674 and/or the SPICE model simulation module 676 generate a circuit schematic configuration interface 732, an implementation of which is illustrated in FIG. 36. In various system implementations, the circuit schematic configuration interface may be pre-populated with a circuit schematic/design 734 already associated with the particular module chosen or may include a canvas on which the user can free hand enter various circuit components and enter corresponding component values and parameters or where the user can edit a schematic shown. As illustrated in FIG. 36, the circuit schematic configuration interface 732 may also include one or more tables 736 where various parameters for circuit components or portions of the circuit can be set/selected/entered by the user. When all required and/or desired parameters have been entered, the user selects the “Save” button or similar control 738 and the parameters are transmitted to the module system module 672, the three dimensional simulation module 674, and/or the SPICE model simulation module 676 to initiate modeling activities by the various modules.

During modeling, the three dimensional simulation module 674 uses the module configuration file, the module bonding diagram, and the product SPICE model of the module to carry out thermal and electrical modeling in three dimensions to generate a product SPICE model that includes module packaging. In various implementations, the product SPICE model includes at least one die SPICE model, a module packaging parasitic extraction model, and a thermal model that includes module packaging. The product SPICE model that includes module packaging is then transmitted to the SPICE model simulation module 674 for additional simulation, modeling, and preparation of system outputs.

The parameters gathered during the design process from the user include one or more process conditions under which the module operates along with one or more system characteristics, one or more operating characteristics, and one or more circuit characteristics. The SPICE model simulation module 674 then generates a SPICE model output that includes a product SPICE model that includes product packaging along with the one or more process conditions, the one or more system characteristics, the one or more operating characteristics, and the one or more circuit characteristics. The SPICE model simulation module 674 also utilizes a formatting module included therein to format the SPICE model output into a product system model file where the product system model file includes or is in the form of a structured text file, a plain text file, or a delimited text file. In various implementations, the product system model file is set up to allow it to be used in a system level simulation of an electrical system/circuit/design that includes the product type corresponding to the particular semiconductor module that has been designed. In some implementations, the product system model file is a structured text file designed for use by a Piecewise Linear Electrical Circuit Simulation (PLECS) system like any disclosed in this document and may be formatted using any of the exemplary formats disclosed herein. The outputs of the product system model file when employed by a system-level simulator may be like any disclosed in this document as well.

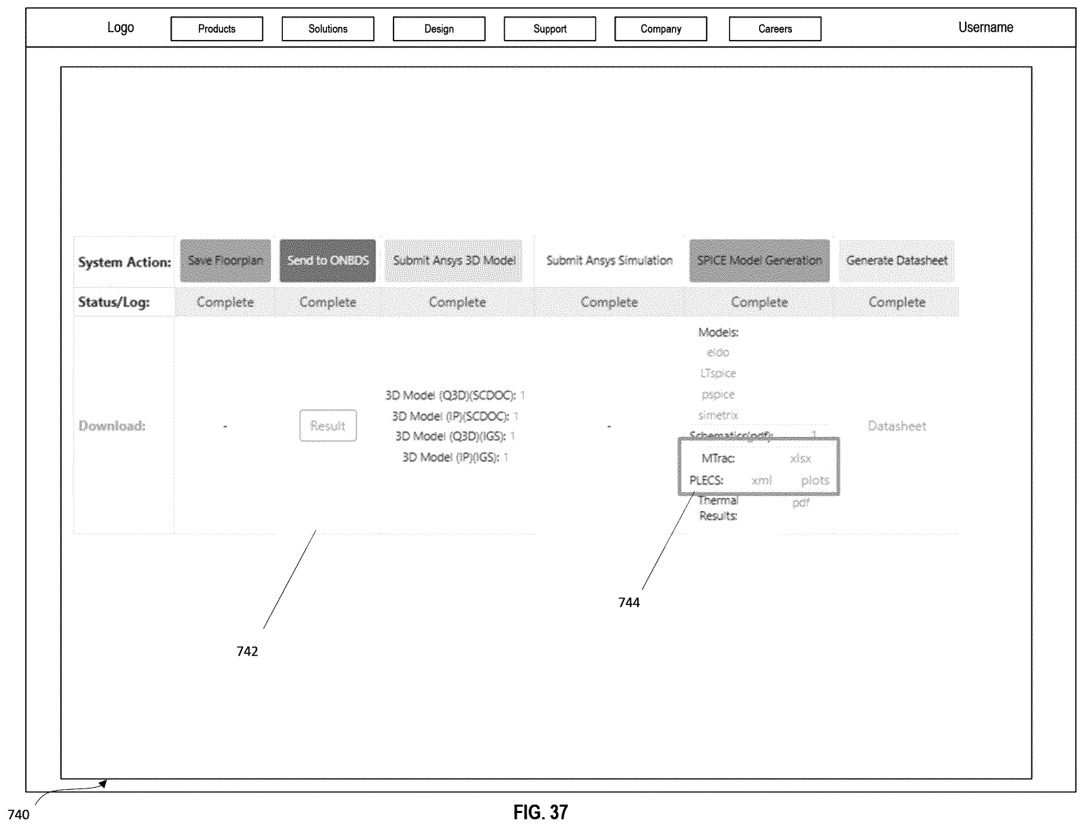

Following the completion of the generation of the product system model file, referring to FIG. 37, the SPICE model simulation module 674 generates system output interface 740 which contains a table 742 which contains links or other controls that allow the user to access, view, and/or download the various models, output files, and datasheets created during the module design, modeling, and simulation processes disclosed herein. The indicated models 744 in the table 742 are system models that can be used by a system-level simulator by the user to conduct additional design work with the module that has been designed using the system.

The ability for users who are customers who are wishing to purchase modules manufactured by a vendor to use the vendor's site to do their design, modeling, and simulation preparation work can greatly assist the customers in their design cycles. By using data provided directly by and updated by the vendor along with accurate models, circuit designs, and parameters, the customer can experience a reduction in design cycle time and a reduction in design-related errors. Design-related errors can be extremely costly and disruptive to a customer's business as some errors cannot be corrected in the field but require an entire redesign and rebuild of a circuit/system. Thus, the ability of the customer to not have to manually collect and gather information from various datasheets, manually enter that information, and manually build circuit schematics for the die and module(s) that will be included can greatly assist in ensuring the design is completed accurately and as desired. Also, the ability to generate modeling outputs ready for immediate use in system-level simulators for electrical, thermal, and/or parasitic performance of a module can greatly enhance the customer's ability to produce a product that will work the first time by avoiding designs that are marginal or created unforeseen operating conditions causing failures or poor performance.

The various system implementations that operate using the flow diagram illustrated in FIG. 25 may employ similar processor, related hardware, and networking equipment like that disclosed in the other system implementations related to FIGS. 1 and 23 disclosed herein. They may also utilize portable computing devices and other computing devices that are remote platforms and external resources that are involved in generating computing interfaces and/or inputting data into computing interfaces using any of the similar systems and methods disclosed herein for the system implementations relating to FIGS. 1 and 23. A wide variety of system and method implementations may be constructed using the principles disclosed herein. In places where the description above refers to particular implementations for designing a module product and implementing components, sub-components, methods and sub-methods, it should be readily apparent that a number of modifications may be made without departing from the spirit thereof and that these implementations, implementing components, sub-components, methods and sub-methods may be applied to other techniques for designing a module product.

What is claimed is:

1. A system configured for designing a semiconductor device product, the system comprising:
one or more hardware processors configured by machine-readable instructions to:
provide access to the system using a portal interface;
using a product design interface, receiving a selection of a discrete device product design option and activating a discrete device product system configured to:
receive from a user a selection of at least one discrete device die and a selection of at least one test condition;
generate a product die configuration using the at least one discrete device die and a predictive modeling module;
generate a graphic design system file using a graphic design system module with the product die configuration;
generate a package bonding diagram using a build diagram system module with the graphic design system file;
generate a product SPICE model corresponding with the product die configuration with a product SPICE model generating module;
provide the product SPICE model to a product simulation module;
generate one or more datasheet characteristics of a discrete device product with the product SPICE model using the product simulation module;
provide the one or more datasheet characteristics to a datasheet formation module;
generate product datasheet for the discrete device product using the graphic design system file, the package bonding diagram, and the one or more datasheet characteristics; and
provide access to the graphic design system file, the package bonding diagram, the product SPICE model, and the product datasheet to the user.

2. The system of claim 1, wherein the system is further configured to: receive a selection of a package type, include the package type in the product die configuration, select a die SPICE model corresponding with the at least one discrete device die, and select a package SPICE model corresponding with the package type for generating the product SPICE model with the product SPICE model generating module.

3. The system of claim 1, wherein the build diagram system module uses a virtual clip to generate the package bonding diagram.

4. The system of claim 1, further comprising:
with the one or more hardware processors configured by machine-readable instructions to:
receive a selection of a module type;
generate a module configuration file;
generate a module bonding diagram;
provide the module configuration file, the module bonding diagram, and the product SPICE model to a three dimensional simulation module;
generate a three dimensional model for the module using the three dimensional simulation module; and
provide access to at least the module bonding diagram, a product SPICE model that includes module packaging, and the three dimensional model to the user.

5. The system of claim 4, wherein the product SPICE model comprises at least one die SPICE model, a module packaging parasitic extraction model, and a thermal model including module packaging.

6. The system of claim 4, wherein the system is configured to provide access to a module schematic diagram.

7. The system of claim 1, further comprising:
with the one or more hardware processors configured by machine-readable instructions to:
receive a selection of a module type;
generate a module configuration file;
generate a module bonding diagram;
provide the module configuration file, the module bonding diagram, and the product SPICE model to a three dimensional simulation module; and
generate a product SPICE model that includes module packaging.

8. The system of claim 7, wherein the product SPICE model that includes module packaging comprises at least one die SPICE model, a module packaging parasitic extraction model, and a thermal model including module packaging.

9. The system of claim 4, further comprising:
with the one or more hardware processors configured by machine-readable instructions to:
with the product SPICE model including module packaging associated with the module type:
receive from the user a selection of a process condition;
receive from the user one or more system characteristics and one or more operating characteristics;
receive from the user one or more circuit characteristics;
use a SPICE model simulation module to generate a SPICE model output with the product SPICE model that includes module packaging, the process condition, the one or more system characteristics, the one or more operating characteristics, and the one or more circuit characteristics; and
use a formatting module to format the SPICE model output into a product system model file, the product system model file comprising one of a structured text file, a plain text file, or a delimited text file.

10. The system of claim 9, wherein the product system model file is configured to be used to perform a system level simulation of a system comprising the module type.

11. The system of claim 9, wherein the product system model file is a structured text file configured to be used by a Piecewise Linear Electrical Circuit Simulation system.

12. A method of designing a semiconductor device product, the method comprising:
receiving from a user a selection of at least one discrete device die and a selection of at least one test condition;
generating, using a processor, a product die configuration and a product package configuration using a predictive modeling module and the at least one discrete device die;
generating, using the processor, a graphic design system file using a graphic design system module with the product die configuration;
generating, using the processor, a package bonding diagram using a build diagram system module with the graphic design system file;
generating, using the processor, a product SPICE model corresponding with the product die configuration using a product SPICE model generating module;
providing, using the processor, the product SPICE model to a product simulation module;
generating, using the processor, one or more datasheet characteristics of a discrete device product with the product SPICE model;
providing, using the processor, the one or more datasheet characteristics to a datasheet formation module;
generating, using the processor, a product datasheet for the discrete device product using the graphic design system file, the package bonding diagram, and the one or more datasheet characteristics; and
providing access to the graphic design system file, the package bonding diagram, the product SPICE model, and the product datasheet to the user.

13. The method of claim 12, further comprising: receiving a selection of a package type, including the package type in the product die configuration, selecting a die SPICE model corresponding with the at least one discrete device die, and selecting a package SPICE model corresponding with the package type for generating the product SPICE model with the product SPICE model generating module.

14. The method of claim 12, wherein the build diagram system module uses a virtual clip to generate the package bonding diagram.

15. The method of claim 12, further comprising:
receiving a selection of a module type;
generating, using the processor, a module configuration file;
generating, using the processor, a module bonding diagram using a build diagram system module with the module configuration file;
providing, using the processor, the module configuration file, the module bonding diagram, and the product SPICE model to a three dimensional simulation module;
generating, using the processor, a product SPICE model including module packaging;
generating a three dimensional model for a module semiconductor product using the three dimensional simulation module; and
providing access to at least the module bonding diagram, the product SPICE model including module packaging, and the three dimensional model to the user.

16. The method of claim 15, wherein the product SPICE model including module packaging includes at least one die SPICE model, a module parasitic extraction model including packaging, and a thermal model including packaging.

17. The method of claim 15, further comprising:
using the processor, receiving from a user a selection of a product type;
selecting, using a processor, the product SPICE model including module packaging associated with the module type;
using the processor, receiving from the user a selection of a process condition;
using the processor, receiving from the user one or more system characteristics and one or more operating characteristics;
using the processor, receiving from the user one or more circuit characteristics;
using the processor and a SPICE model simulation module, generating a SPICE model output with the product SPICE model, the process condition, the one or more system characteristics, the one or more operating characteristics, and the one or more circuit characteristics; and
using the processor and a formatting module, formatting the SPICE model output into a product system model file, the product system model file comprising one of a structured text file, a plain text file, or a delimited text file.

18. The method of claim 17, wherein the product system model file is configured to be used to perform a system level simulation of a system comprising the product type.

19. The method of claim 17, wherein the one or more operating characteristics further comprises one of at least one direct current characteristic, at least one switching characteristic, at least one gate threshold voltage, or any combination thereof.

20. The method of claim 17, wherein the product system model file is a structured text file configured to be used by a Piecewise Linear Electrical Circuit Simulation system.
